(19) United States
(12) Patent Application Publication
(10) Pub. No.: US 2009/0220136 A1
(43) Pub. Date: Sep. 3, 2009

(54) Image Guidance System for Deep Brain Stimulation

(75) Inventors: Frank J. Bova, Gainesville, FL (US); Atchar Sudhyadhom, Gainesville, FL (US); Michael S. Okun, Gainesville, FL (US); Kelly D. Foote, Gainesville, FL (US)

Correspondence Address: EDWARDS ANGELL PALMER & DODGE LLP, P.O. BOX 55874, BOSTON, MA, 02205, US

(73) Assignee: University of Florida Research Foundation, Gainesville, FL (US)

(21) Appl. No.: 12/223,524

(22) PCT Filed: Feb. 1, 2007
(86) PCT No.: PCT/US2007/002908

§ 371 Date: Dec. 16, 2008

Related U.S. Application Data
(60) Provisional application No. 60/765,317, filed on Feb. 3, 2006.

(51) Int. Cl. G06K 9/00; G06T 15/00; G06K 9/36

(52) U.S. Cl. 382/131; 345/419; 382/285

(57) ABSTRACT

This invention provides computerized image guidance systems for deep brain stimulation (DBS) surgery and related methods that improve accuracy of positioning of electrodes in the brains of subjects. Image guidance systems in accordance with the present invention incorporate advanced features such as capability of displaying, in any desired plane of view, a digitized three-dimensional neuroanatomical brain map that can be form fitted to a patient's medical images, such as brain MR images, and capability of displaying on the patient's medical images both the contours of anatomic structures from a digitized brain map, and digitized electrode recording data obtained intra-operatively.

### CROSS-REFERENCE TO RELATED APPLICATIONS

The present application claims the benefit of priority under 35 U.S.C. § 119(e) to U.S. Provisional Patent Application No. 60/765,317, entitled Image Guidance System for Deep Brain Stimulation, filed Feb. 3, 2006, the disclosure of which is incorporated herein by reference in its entirety.

### FIELD OF THE INVENTION

The invention generally relates to methods for treating neurological diseases and disorders by neurosurgery. More particularly, it relates to therapeutic methods and systems for electrically stimulating the brain by deep brain stimulation (DBS).

### BACKGROUND

Deep brain stimulation (DBS) therapy has grown as an appealing alternative or supplement to medication for treatment of neurological disorders including movement disorders. The surgical requirements for effective DBS demand accurate, sub-millimeter targeting of the region to be stimulated. Multiple techniques are utilized to provide the neurologist and neurosurgeon with the data necessary to make a decision with respect to placement of a stimulating electrode. One standard procedure involves an initial targeting of the position to be stimulated from a medical image such as a cranial magnetic resonance image (MRI), followed by acquisition of microelectrode data to refine the initial targeting. Refinement of initial targeting is necessary because the cranial image typically has poor contrast and resolution in the region of interest. Such a limitation is unlikely to allow for proper targeting alone.

The state of the art in the field is such that microelectrode data is acquired by hand, plotted on graph paper, and compared to a printed brain atlas to determine the position in the patient's brain that corresponds to a similar anatomic or physiologic position in the atlas. Due to manual data acquisition and the use of a printed brain atlas, there are several inherent limitations placed on microelectrode data acquisition. It would be desirable to overcome limitations in the manual methodology for targeting in DBS. In particular, it would be valuable for DBS practitioners to have access to computerized systems designed for intraoperative use that could enhance visualization of electrode target structures on images of patient's brains, and could acquire microelectrode data and enable its visualization in combination with the patient's cranial anatomy.

### SUMMARY OF THE INVENTION

The invention relates generally to an image guidance system for intra-operative use during DBS surgery. More particularly, in the development of various aspects of the inventive system, computer programs were created to enhance precision of microelectrode targeting to areas of the brain, to acquire microelectrode data, and to visualize microelectrode data overlaid on images of the subject's brain.

A first aspect of the system centers on the creation and use of a computer-implemented three-dimensional digital neuroanatomical map of the brain, derived from two-dimensional images as our typically included in printed atlases of neuroanatomy. A computerized system for enhancing visualization of structures in three dimensions in medical images of the brains of subjects further incorporates the three-dimensional neuroanatomic map of the brain, and allows for display and transformation of atlas structures and reference points onto medical images of the patient's brain, such as those obtained by MRI. In this way, the inventive systems greatly improve visualization of anatomic regions and structures of interest for targeting with DBS electrodes.

Another aspect of the invention is a computerized data acquisition system for DBS. In contrast to prior art methods, microelectrode data is acquired digitally from user input and can be plotted and printed, and stored in one or more independent sites.

A further aspect of the invention is an integrated image guidance system for deep brain stimulation (DBS) surgery in which microelectrode data can be displayed on a digital atlas for viewing and form fitting (either manually or automatically) to a position in the atlas that represents the patient's anatomy. The end result is knowledge of the location in the patient's anatomy of a DBS probe, in relation to the reference anatomy of the atlas.

Accordingly, and in one aspect, the invention provides a computer-implemented three-dimensional neuroanatomic map of the brain comprising digitized images of anatomic structures, contours, and reference points in the brain that may be visualized unambiguously on a display in two or three dimensions, and viewed from any desired plane of section through said brain.

In one embodiment, the three-dimensional images in the brain map are constructed using digitized information contained in a series of two-dimensional images depicting brain structures and functions in discontinuous sections through a reference brain from one or more subjects.

In one embodiment, the discontinuous sections of the reference brains from which the digitized three-dimensional neuroanatomic map is constructed are oriented through the sagittal, axial, or coronal planes of section.

In some embodiments, the digitized information is obtained from discontinuous sections oriented through at least two planes of section from one or more reference brains.

In some preferred embodiments of the computer-implemented neuroanatomic brain map, the sections are aligned with each other using an anatomic coordinate system.

In some embodiments of the digitized brain map, the discontinuous sections used for construction are in sagittal orientation, and the horizontal axis defines the commissural line, and the vertical axis defines the mid-commissural plane.

In other embodiments of the computer-implemented neuroanatomic brain map, the discontinuous sections used for construction are in axial orientation and a single horizontal axis in each section defines the mid-commissural plane, with the most medial portion of that axis defining the mid-sagittal plane. In some of these embodiments, the coordinates are calculated to account for the deviation of Reid's plane from the AC-PC plane.

In some versions of the digitized brain maps, the digitized images comprise only the contours of a structure of interest in the brain, and in some preferred embodiments, undesired features of structures of interest are removed.

In some versions of the computer-implemented neuroanatomic brain maps, the surface and volume of an anatomic structure of interest defined by a set of points are determined by linear interpolation using triangulation of the points or tessellation of contours. The surface may be smoothed using voxelization, or a smoothing algorithm implemented by convolving with a smoothing kernel.

In some embodiments of the digitized brain maps, the volume of an anatomic structure of interest is determined using Delaunay tetrahedrization.

Some versions of the computer-implemented neuroanatomic brain maps of the invention comprise images combined from two or more voxelized atlases.

In some cases, the computer-implemented neuroanatomic brain maps of the invention are validated by comparison with a three-dimensional model generated from the data used to construct the brain map.

Another aspect of the invention is a computerized system for enhancing visualization of structures in three-dimensional space in medical images of the brain of a subject. The computerized system comprises: (a) a processor for displaying medical images of the subject's brain; (b) an algorithm for generating a three-dimensional neuroanatomic brain map; (c) an algorithm for converting the medical images of (a) to images capable of integration with the three-dimensional neuroanatomic brain map of (b); (d) a user interface for entering reference points from the subject's medical brain images that define reference points in an anatomically-based coordinate system; (e) an algorithm for transforming data points in the subject's medical image from stereotactic space to anatomic coordinates in the three-dimensional neuroanatomic brain map; and

(f) an algorithm for overlaying images of a three-dimensional brain map on the subject's medical images; and optionally translating and scaling the three-dimensional brain map images to fit the subject's medical images, thereby enhancing visualization of structures in medical images of the brain.

In various versions of the system, the medical image of the brain is obtained using a medical imaging device selected from the group consisting of a MRI device, a CT scanner, an ultrasound device or an X-ray device. In a particularly preferred embodiment, the medical image of the brain is obtained using a MRI device.

Yet a further aspect of the invention is a computerized data acquisition system for deep brain stimulation (DBS), comprising: (a) a user interface for inputting information; (b) at least one algorithm for receiving inputted information selected from the group consisting of main patient information, microelectrode track information, Unified Parkinson's Disease Rating Scale (UPDRS), Tremor Rating Scale (TRS), microelectrode data, microstimulation data, motor function measurements, and macrostimulation data; and (c) a plotting and printing routine.

Some embodiments of the computerized DBS data acquisition system of are further configured to store saved information in one or more independent sites.

In various embodiments, microelectrode data that can be entered into the data acquisition system can include one or more of: electrode number, time of recording, depth of the electrode, position of the electrode in a fixed three-dimensional coordinate system, quality of the recording, cell type descriptor, location of recorded cell and certainty thereof, body part location, motor function measurements, and movement associated with a cell.

In one preferred embodiment of the computerized DBS data acquisition system of the invention, the location of the body part can be selected from the striatum, thalamus, Voa, Vop, Vim, Vc, STN, SNr, GPe, GPi, ansa lenticularis, ZI, internal capsule, optic tract, border of striatum, border of thalamus, border of Voa, border of Vop, border of Vim, border of Vc, border of STN, border of SNr, border of GPe, border of GPi border of ansa lenticularis, border of ZI, border of internal capsule, border of optic tract, nucleus accumbens, top, bottom, or other.

In one embodiment of the DBS data acquisition system, the cell type descriptors can include unidentified negative potential (Neg), injury, popcorn, bursting, pausing, high frequency discharge (HFD), low-frequency discharge (LFD-P), chugging, low amplitude; high amplitude, tactile, light touch, rhythmic, background up, background down, quiet, or other.

In versions of the data acquisition systems preferred for neurosurgical procedures, the body part location can be selected from face, cheek, inner mouth, tongue, jaw, chin, neck, shoulder, elbow, arm, hand, wrist, finger, hip, leg, knee, ankle, foot, or toes. Movements associated with particular cells upon stimulation can include abduction, adduction, extension, flexion, internal rotation, external rotation, dorsiflexion, or plantar flexion.

The DBS data acquisition systems can further comprise microstimulation data choices selected from depth of stimulation, type of stimulation (electrical or light), current of stimulation, and response to stimulation (positive or negative).

Yet another aspect of the invention is an integrated computerized image guidance system for deep brain stimulation (DBS) surgery, comprising: (a) a computerized system for enhancing visualization of structures in three-dimensional space in medical images of the brain of a subject, comprising: algorithms for transforming data points in the subject's medical brain images from stereotactic space to anatomic coordinates in a three-dimensional neuroanatomic brain map, and for overlaying images of the three-dimensional brain map on the subject's medical images; (b) a computerized DBS data acquisition system; and: (c) an algorithm that permits the user to display an enhanced three-dimensional neuroanatomic map of the brain from (a) and digitized microelectrode data from the data acquisition system of (b), wherein the microelectrode data appears as an overlay on a three-dimensional neuroanatomic map of the subject's brain.

In some embodiments of the DBS image guidance system of the invention, the system (a) for enhancing visualization of structures in three-dimensional space in medical images of the brain of a subject can comprise at least one of: a processor for displaying medical images of the subject's brain; an algorithm for displaying a three-dimensional neuroanatomic brain map; an algorithm for converting the medical images of the brain to images capable of integration with said three-dimensional neuroanatomic brain map; a user interface for entering reference points from the subject's medical brain images that define reference points in an anatomically-based coordinate system; an algorithm for transforming data points in the subject's brain image from stereotactic space to anatomic coordinates in the neuroanatomic brain map; and an algorithm for overlaying images of a three-dimensional brain map on the subject's medical images; and optionally translating and scaling the three-dimensional brain map, thereby enhancing visualization of structures in the medical images of the brain.

In other embodiments of the DBS image guidance system of the invention, the DBS data acquisition system (b) can comprise at least one of: a user interface for inputting information; algorithms for receiving inputted information selected from main patient information, microelectrode track information, Unified Parkinson's Disease Rating Scale (UPDRS), Tremor Rating Scale (TRS), microelectrode data, microstimulation data, motor function measurements, and macrostimulation data; and a plotting and printing routine.

In certain preferred DBS image guidance systems in accordance with the invention, the microelectrode tracks can be visualized in a para-sagittal view, a para-coronal view, or a three-dimensional view. A selected portion of the brain map and the corresponding microelectrode tracks, or the entire brain map and all of the microelectrode tracks, can be displayed.

In various embodiments of the DBS image guidance system in accordance with the invention, the medical image of the brain is obtained using a medical imaging device selected from the group consisting of a MRI device, a CT scanner, an ultrasound device or an X-ray device. In certain preferred embodiments, the image is obtained with a MRI device.

Accordingly, it is an object of the invention to provide computerized systems that overcome several limitations of the DBS intra-operative procedure by providing enhanced targeting for placement of stimulating electrodes for DBS. Other aspects and advantages of the invention are discussed below.

### BRIEF DESCRIPTION OF THE DRAWINGS

FIG. 1 is a photograph illustrating a system for determining a trajectory for placement of an electrode for deep brain stimulation (DBS) based on radiological imaging (fusion of MRI and CT images) of the head of a patient prepared for DBS surgery, in accordance with an embodiment of the invention.

FIGS. 2A and 2B are photographs showing an MR image of a sagittal section of patient's brain without (2A) and with (2B) overlay of atlas contours, in accordance with an embodiment of the invention.

FIG. 3 is a flowchart illustrating components and flow of information in a DBS image guidance system, in accordance with an embodiment of the invention.

FIGS. 4A-C are three drawings showing a coordinate system (indicated by single or crossed lines) used to realign images in the system, in accordance with an embodiment of the invention.

FIGS. 5A and 5B are two drawings illustrating representations of the surfaces of the subthalamic nucleus (A, polyhedral; B wire mesh representation) reconstructed by tessellation of contours and smoothing, in accordance with an embodiment of the invention.

FIG. 6 is a drawing showing a schematic three-dimensional view of unregistered contours of a GPi, in accordance with an embodiment of the invention.

FIGS. 7A and 7B are two drawings showing digitally reconstructed and registered Gpi structures, in accordance with an embodiment of the invention.

FIG. 8 is a photograph of a three-dimensional physical representation (model) of the striatum, GPe and GPi, created in accordance with an embodiment of the invention.

FIG. 9 is a photograph showing an image from the MRAtlas program showing an MR image with fitted atlas contours, in accordance with an embodiment of the invention.

FIG. 10 is a drawing showing an exemplary patient data entry screenshot from the DBS Data Acquisition program, in accordance with an embodiment of the invention.

FIG. 11 is a photograph showing a printout of microelectrode data from the DBS Data Acquisition program, in accordance with an embodiment of the invention.

FIG. 12 is a photograph showing a screenshot from the MicroAtlas program used to display microelectrode data, in accordance with an embodiment of the invention.

FIGS. 13A-C are three drawings showing intensity data from a 49×49×49 voxel cube used to evaluate a component of a DBS system, in accordance with an embodiment of the invention.

FIG. 14 is a drawing of a Venn diagram showing atlas structures (print and digital), in accordance with an embodiment of the invention.

FIG. 15 is a graph comparing a reconstruction of the GPi using a printed atlas and a digitally reconstructed atlas, in accordance with an embodiment of the invention.

FIGS. 16A-C are three drawings showing a print atlas overlaid with contours from a digitally reconstructed atlas of the same section of the brain, in accordance with an embodiment of the invention.

FIGS. 17A-B are two drawings illustrating unregistered (A) and registered (B) reconstructions of GPi structures, in accordance with an embodiment of the invention.

FIGS. 18A-B are two drawings showing manual (A) and automated (B) matching of electrode placement in brain structures, in accordance with an embodiment of the invention.

FIG. 19 is a drawing showing a typical prior art head ring used in the inventive system to provide coordinates for electrode placement in DBS surgery, in accordance with an embodiment of the invention.

### DETAILED DESCRIPTION OF THE INVENTION

Deep brain stimulation (DBS) is a relatively new and innovative treatment first recognized as effective for several common neurological disorders. More recently, it is being used or proposed for treatment of a wide variety of disorders, including obesity and depression. To date, DBS has been found to be especially useful in the treatment of movement disorders such as Parkinson's disease (1), essential tremor (2), dystonia, and Tourette's syndrome (3).

Since the introduction of levadopa, Parkinson's disease has been viewed as a medicinally treatable disorder over surgical means, such as DBS. With the advent of stereotactic neurosurgical techniques, treatment philosophies have been adjusted to include ablative therapies and DBS as viable forms of treatment. In the specific case of Parkinson's disease, the substantia nigra pars compacta is found to be abnormal in patients, which causes a cascading change of excitatory and inhibitory pathways in other nearby structures. In particular, certain neural structures such as the subthalamic nucleus (STN) and globus pallidus interna (GPi) are found to be inappropriately regulated (4), and thus are targets for DBS or ablation in Parkinson's disease.

In ablative treatments, either a radiofrequency ablation or stereotactic radiosurgery ablation (5, 6) is created at the site of interest. This ablation effectively restores the excitatory and inhibitory pathways to a seemingly normal functionality. While the exact mechanism by which DBS works to alleviate the effect of disease symptoms is not thoroughly understood, it is generally believed that DBS either creates a functional ablation in the structure that is stimulated, or that it activates the structure that is being stimulated (7). DBS has become the preferred method over ablative procedures due to its reversibility, and the ability to program the stimulating electrode to meet the patient's changing needs.

### Prior Art Procedures for Electrode Placement in Deep Brain Stimulation (DBS) Surgery

Generally, the clinical procedure for DBS is an image-based microelectrode-guided procedure that is achieved through a series of laborious and painstaking steps involving participation of highly skilled specialists. In order to localize a target site for stimulation by a DBS stimulation electrode, skilled practitioners use multiple localization techniques to determine the location of the target, which, as discussed, requires accuracy at the sub-millimeter level.

To enhance appreciation of the advantages of the current invention, a brief description of procedures in current use is first presented. The microelectrode targeting process in current use can be divided into three major steps, i.e., targeting based on radiological imaging (direct targeting); microelectrode-based (indirect) targeting; and DBS stimulation electrode placement. The entire process involves delicate neurosurgery and requires extremely accurate targeting of the intended point of stimulation. Although the DBS procedure is advanced, the standard methodology used, prior to the development of the inventive system, encompasses many manual steps that hinder the surgical operation and the ability of the medical team to accurately target the point of interest.

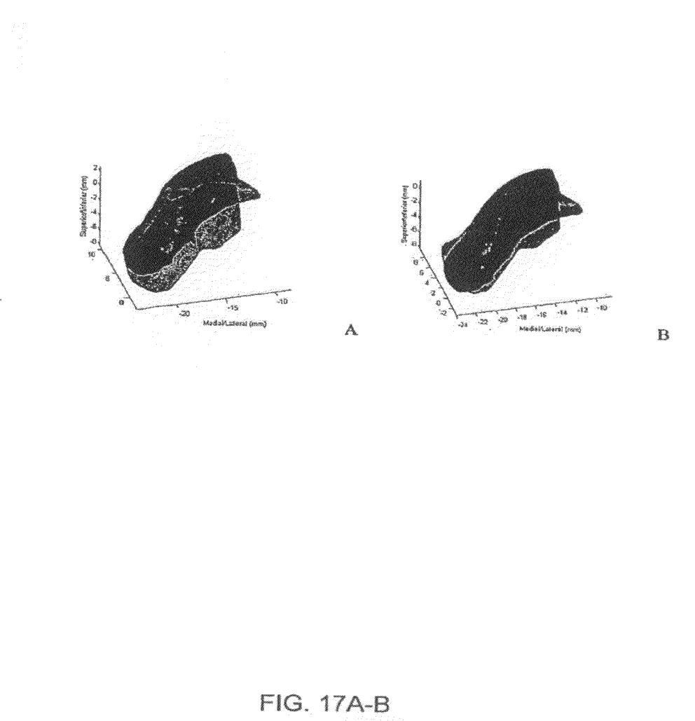

More specifically, in advance of the surgical procedure, a series of images of the patient's brain is obtained using a medical imaging device. Typically a non-stereotactic magnetic resonance image (MRI) of a patient's cranium is acquired, e.g., using a 3D magnetization-prepared rapid gradient echo (3D MP RAGE) technique. The MRI image is a key to the localization of the target, since the anatomy of interest typically exhibits poor contrast characteristics in other imaging modalities such as computed tomography (CT). Once the MRI information has been acquired, a stereotactic head ring, e.g., a target-centered Cosman-Roberts-Wells (CRW) head frame (Radionics, Burlington, Mass.) is placed on the patient's head (see, e.g., FIG. 17) and a stereotactic CT scan is taken of the patient's head.

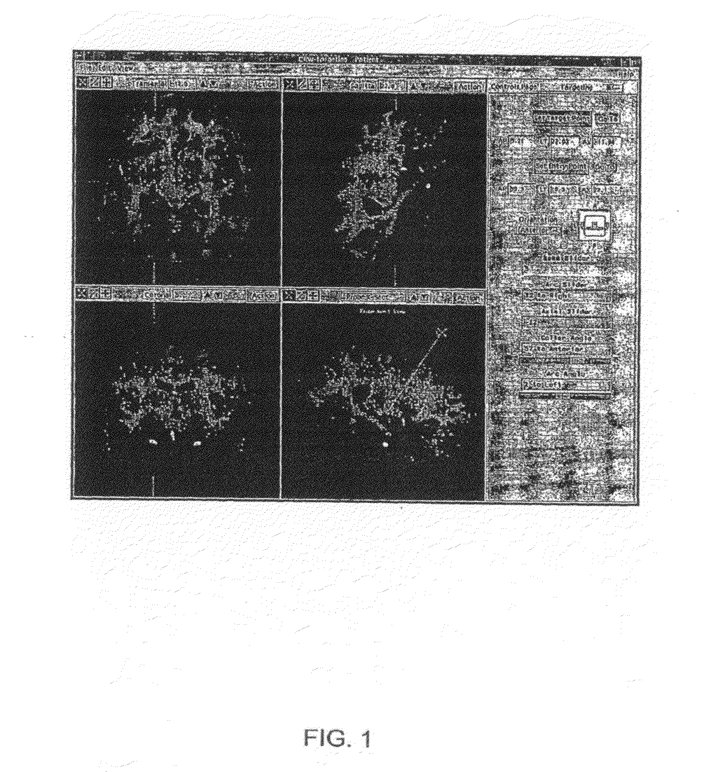

In one preferred method, the MRI image is then fused to the stereotactic CT image using software developed for this purpose. Since the CT image of the patient is taken with the head ring attached, a stereotactic coordinate system based on fiducial markers can be set up. The fusion of the MRI to the CT allows the stereotactic coordinate system to be overlaid onto the MR image, to create a stereotactic MRI. Using the stereotactic MRI, the surgeon can select a target, determine an entry point and calculate a safe surgical trajectory for the electrode (or “probe”). An example of a probe trajectory from a system currently in use at the University of Florida is illustrated in FIG. 1.

While the MR data allows the surgeon to identify anatomic structures, it unfortunately does not contain information that would allow the surgeon to identify the required tissue function. Thus, this structural description alone can get one close to the target, but it does not allow for the definition of the precise target tissues. In order to get this location, the surgical team must insert a microelectrode and actually record the function of individual brain cells. This recording allows the team to identify the individual cell types, providing a more specific categorization of cells, not currently definable through MR scanning.

Once initial targeting from the MRI has been determined, a refinement on this localization is obtained from information gained intra-operatively by the placement and functional testing of one or more microelectrodes. For this procedure, a neurosurgeon makes a small hole in the skull and stereotactically inserts a carrier tube that houses the microelectrode. A typical microelectrode has a tip diameter of 2 to 4 μm with an impedance of 0.5 to 1 MΩ (9), and is used to measure the voltage signal of neurons deep in the brain. The voltage signal is amplified by many orders of magnitude and displayed on an oscilloscope, as well as aurally projected from a speaker system. The sounds emitted by various target tissues and the adjacent brain structures can be identified by a trained clinician. These waveforms provide functional information that can help to more precisely map areas of the brain, (e.g., specific midbrain structures), allowing the clinician to more precisely identify the desired target structure.

This portion of the procedure, which involves designating an electrical signal as corresponding to a region in the patient's anatomy, is referred to as “microelectrode mapping.” Specialized equipment known in the art is used to direct the electrode into the patient's brain and to acquire the voltage signal from the neurons, for example as described by Vitek et al. (9). As the microelectrode is lowered into the patient's brain, the electrode can be stopped, to view the waveform on an oscilloscope and to listen to the sound of the cells at any particular depth along the track.

Once the waveform has been identified as corresponding to a particular anatomic structure in the patient's brain, the location of the cell is recorded by hand on paper. The electrode can be positioned in the patient's brain multiple times in different locations along parallel tracks (each pass of the electrode is referred to as a “track”). Once the data from multiple tracks at various locations have been acquired, the coordinate information, along with the structure that corresponds to that point in the patient's brain, allows the physicians to create a sparsely-defined 3D map of the particular patient's neuroanatomy. Unfortunately, these track data are very limited in the spatial volume that they comprise. A typical track may have 20 to 30 mm of data that provide coordinate locations and their corresponding structures. This information defines a set of points along the track. Each data point along a track is spatially small, i.e., on the order of the size of a single cell. While it would be optimal to complete many tracks, it is typically in the best interest of the patient that the number of tracks is limited. Thus, the map created from the patient microelectrode data is typically sparse in its information and is not sufficient to provide all of the required information to refine the targeting.

While the plotting of the microelectrode data against the MR scan is helpful, it is equally helpful for the surgical team to supplement the MR data with standard anatomic maps. These maps help provide more specific information on tissue function. As with the MR-defined data, these maps are approximate and must be fitted to each individual patient. The microelectrode data is used to guide this fitting process.

Typically a standard brain atlas is used for this purpose. In one preferred method known in the art, relevant atlas pages depicting anatomical structures of interest are copied onto large transparent plastic plates. As the microelectrode recording data is obtained during the OR procedure, a pair of scribes records the data. This data is then overlaid onto the atlas plates, allowing the surgical team to better appreciate the actual location of specific tissues in the patient's brain. One critical function provided by the atlas is the definition of functional boundaries. While these boundaries are different for each patient, their relative locations are reproducible using the methods described.

The most common atlases used for deep brain stimulation surgery are the Schaltenbrand-Wahren (10) and the Schaltenbrand-Bailey (11) series of atlases. A “brain atlas,” as the term is used herein, refers to a set of images with associated delineated regions that are known to correspond to specific anatomic structures in the brain. Typical atlases historically used for this purpose were imaged optically, with contrast provided by histological staining, e.g., myelin staining. The brains used to create the images in the atlases were obtained from cadavers and physically sliced and stained. For use in DBS surgery, as discussed, a coordinate system is placed on these slices for stereotactic localization of particular structures.

The Schaltenbrand-Wahren and Schaltenbrand-Bailey atlases each have three microseries of subcortical structures that were created from cadaver brains of differing hemispheres sliced in the sagittal, trans-axial, and coronal planes. To help with anatomic referencing, the atlases are mapped into a patient-defined anatomic space. A mid-commissural coordinate system is set up on these images, where the mid point of the anterior commissure and the posterior commissure is taken to be the origin (12). The axes of the coordinate system are shown on each slice through the use of a set of crosses. The two atlases of interest have trans-axial slices that were sliced at the Reid's plane and not along the commissural line. Reid's plane is the plane that lays between the infraorbital margin and the upper margin of the external auditory meatus and whose normal lies on the mid-sagittal plane. The myelin-stained slices in the atlas are carefully contoured to delineate specific anatomical structures (11).

In order to combine the information from the microelectrode track data with the atlas, the microelectrode track data must be positioned in the corresponding coordinate system of the atlas. Since it is highly unlikely that the atlas, which is created from a particular cadaver brain, will exactly correspond to the patient's brain, the microelectrode data must be repositioned, to correspond to the analogous position in the coordinate system of the atlas. This process of fitting the microelectrode track data to the atlas is known as “form fitting” or “matching” (9). Form fitting of the microelectrode data to the atlas requires that the data itself lies within the plane of one of the available slices in the print atlas. Thus, the tracks of data must be made on sagittal, trans-axial, or coronal planes in order to allow for form fitting.

For clinical reasons, however, a typical track is made in a para-sagittal plane. The atlas itself only has a finite number of slices through the cadaver brain (as it was created by physical slicing of this brain), and is not able to be interpolated due to its non-digital nature. Tracks should optimally follow two conditions for potential exact form fitting. These are: (1) perfectly sagittal tracks must be made through the brain, and (2) the tracks must lie on one of the known slices.

Unfortunately, targeting a particular position in the patient's anatomy that corresponds to an analogous plane in an atlas is not feasible for readily apparent practical reasons. In addition, due to clinical requirements of choosing a safe path for the tracks, the microelectrode may not actually lie on a perfectly sagittal plane. In the case that these two conditions are not met, the microelectrode data may not properly fit the atlas, and only approximate form fitting can be accomplished. Thus, the inability to interpolate the atlas and view it at arbitrary cuts limits the abilities of physicians to accurately choose an entry angle and position.

Once the microelectrode data from the patient has been fitted to a particular region in the atlas, the clinicians are able to approximate where they are in the atlas coordinate system. At this point, a DBS stimulating electrode is placed into the patient's brain. Proper placement is verified by testing the effect of stimulation intra-operatively. During the entire mapping procedure, the patient is awake. The physician is able to ask the patient to complete a series of simple tasks to demonstrate the effect of the electrode on his or her symptoms. If it is determined that the placement could be improved, the electrode is repositioned. Otherwise, the parameters of the stimulating electrode are tested and limits on voltage settings are found. At some later time, usually a few weeks, a stimulator is implanted and is programmed to provide the stimulation required to achieve the desired clinical effect.

In summary, as discussed, the efficacy of DBS is highly reliant on accurate localization of the proper point of stimulation. The ability to precisely target solely from the patient medical image such as a cranial MRI is dependent on having high contrast in the region of interest and of the anatomical target structures; it is also necessary to obtain scans that have a high resolution of target structures. Routinely obtained scans do not offer the necessary contrast of target anatomic structures to be able to adequately define the structures of interest. Although it is possible to use unpinned tissue contrast (14), there is an inverse relationship between contrast and spatial resolution that is often observed. Furthermore, at many DBS facilities, microelectrode data is recorded and plotted by hand. To augment the sparse data inherent in the microelectrode tracks, a print version of a brain atlas such as the Schaltenbrand-Bailey atlas is used and, as mentioned supra, only provides sagittal slices at particular locations. To allow for precise mapping, the microelectrode tracks must be performed on a perfectly sagittal plane in the patient's brain. As a consequence of the microelectrode data and atlas being in print form, the microelectrode track data must be manually overlaid and fit to the atlas. The CRW arc system does not easily provide true sagittal trajectories, so the manual form fitting of the patient's data to the atlas is not precise and is very dependent upon individual user bias. The end result is a non-reproducible mapping process.

### Improved Guidance System for DBS Surgery

The inventive systems and methods disclosed herein address several limitations that are inherent in the above-described manual aspects of the procedure, more particularly by providing a computer-implemented digitized three-dimensional neuroanatomical brain map; by providing a computerized DBS data acquisition system for recording the physician-provided structure identification along a microelectrode path; and by providing a computerized system for display of an atlas-enhanced digital map of the patient's brain anatomy overlaid with digitized microelectrode data. The following sections provide a brief introduction to several novel aspects of the developed systems, which are further described in detail infra and in the Examples.

### Computer-Implemented Three-Dimensional Neuroanatomic Map of the Brain

As discussed above, some of the limitations of the prior art intra-operative methodology for DBS surgery center on the inability to view an atlas of the brain from arbitrary planes, such as are typically needed for planned trajectories of electrodes into brains of human patients. To overcome this problem, in one aspect the invention provides a computer-implemented three-dimensional neuroanatomic map of the brain comprising digitized images of anatomic structures, contours, and reference points in the brain that may be visualized unambiguously on a display in two or three dimensions, and viewed from any desired plane of section. In some embodiments, the digitized information is obtained from discontinuous sections oriented through at least two planes of section from one or more reference brains. In some preferred embodiments of the computer-implemented neuroanatomic brain maps, the sections are aligned with each other using an anatomic coordinate system.

In some embodiments of the digitized brain maps, the discontinuous sections used for construction of the 3-D brain maps are in sagittal orientation, and the horizontal axis defines the commissural line, and the vertical axis defines the mid-commissural plane.

Those of skill in the art will recognize that a digitized three-dimensional anatomical map can be created in accordance with the teachings of the present specification from any images in a suitable atlas of anatomy, in print or otherwise, and, in preferred embodiments, from any suitable atlas of neuroanatomy. Suitable anatomical atlases are well known to those of skill in the art and are further described infra.

In certain embodiments of the three-dimensional brain maps described in the Examples, digital atlases were created based on the Schaltenbrand-Bailey neuroanatomical microseries. A preferred embodiment of a digitized atlas thus created contains a set of fourteen subcortical structures that include the anterior commissure (AC), globus pallidus externa (GPe), globus pallidus interna (GPi), cranial nerve II or optic tract (OT), red nucleus (Ru), substantia nigra reticulata (SNr), subthalamic nucleus (STN), striatum (Str), thalamus (thal), ventral caudal nucleus of the thalamus (Vc), ventral intermediate nucleus of the thalamus (Vim), ventral oralis anterior (Voa), ventral oralis-posterior (Vop), and zona-incerta (ZI). The final digitized atlas itself is in the form of 0.25 mm by 0.25 mm by 0.25 mm voxels, but the invention is not so limited and any other suitable voxel size may be used. Further details of the methods and programs used to create particular embodiments of the three-dimensional neuroanatomic atlases are described infra

### Computerized System for Enhancing Visualization of Structures in Three-Dimensional Space in Medical Images

The MRI of the patient's brain used for DBS surgery is typically of poor spatial resolution, (about 1.0 mm), and of low contrast for the regions and structures of interest. In particular, three neural structures that are common targets of deep brain stimulation, i.e., the STN, the GPi, and the VIM of the thalamus are typically entirely indistinguishable from the surrounding anatomical structures by routine medical imaging procedures such as by MRI.

In order to improve localization of the targets visible in a patient's medical brain image, such as an MRI, in one aspect the invention provides a computerized system for enhancing visualization of structures in three-dimensional space in medical images of the brain of a subject. Suitable medical images of a subject's brain may be obtained with any suitable medical imaging device such a MRI device, a CT scanner, an ultrasound device or an X-ray device. In a particularly preferred embodiment for DBS surgery, the medical images of the brain are obtained using a MRI device.

The computerized system incorporates a method of enhancing the medical image with structural and/or functional information that is obtained from an atlas of anatomy. Accordingly, the inventive computerized systems are also referred to herein as “atlas-enchanced.” In one preferred embodiment, an atlas-enhanced imaging system in accordance with the present invention includes a display that superimposes the contours of the digitizated neuroanatomical brain map (creation of which is further discussed infra) onto the three-dimensional space of the medical image, such as an MRI of the patient. A computer program contained in the system allows the 3-D brain map to be scaled and translated to fit with the patient anatomy.

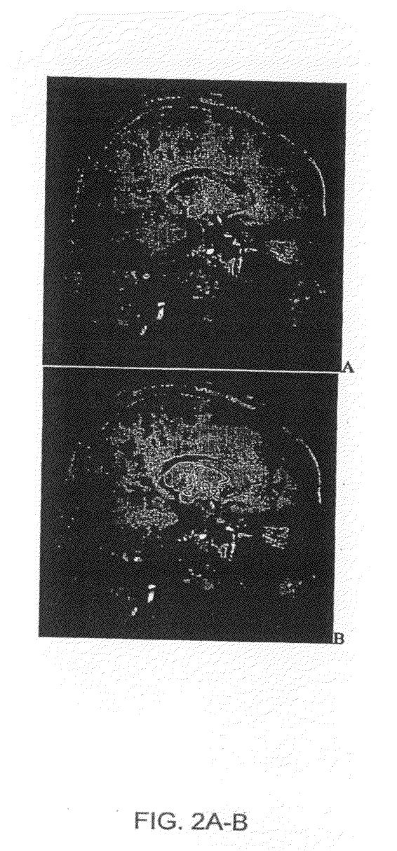

Although all structures of interest may not be distinguishable, neighboring structures of high contrast can be used as landmarks to “morph” or resize the atlas to fit the patient's MRI. As can be seen, for example, by a comparison of FIGS. 2A and 2B, showing sagittal MR images of a patient's brain, an appropriately morphed atlas aids to effectively segment the patient's anatomy. More specifically, the MR image in FIG. 2A is viewed without overlay of the atlas contours, whereas enhanced visualization of structures of interest is apparent in the image in FIG. 2B, in which brain map contours have been overlaid on the MR image by the inventive methods and system, using a program called MRAtlas. By referring to the superimposed image, the neurosurgeon is able to more accurately determine the location of the target tissues. The morphed atlas also allows the neurologist and neurosurgeon to know if and where an atlas is not a particularly good descriptor of an individual patient's anatomy.

### Computerized Microelectrode Data Acquisition System

As discussed above manual methods of data acquisition for microelectrode data present an impediment to improving image guidance systems suitable for use in DBS, especially intra-operatively. For example, the data is not immediately available to create accurate plots and to visualize information in three dimensions. Additionally, manually plotted data derived by prior art methods does not lend itself to data raining for other purposes, including research.

In one aspect, the invention addresses his limitation by providing a robust computerized data acquisition system for DBS that permits digital acquisition and storage of microelectrode data that is created intra-operatively. The system has been refined to ensure that it fulfills several strict requirements. In particular, features of the system are designed to meet the following criteria: flexible data entry that meets the needs of clinicians and researchers; easy-to-navigate layout that allows for quick data entry; availability of numerous options that do not slowdown data entry; and provision of a redundant data storage system to prevent loss of data. As will be apparent to those of skill in the art, many variations on the invention as disclosed herein are possible. A particular program that was developed to implement these features in one preferred embodiment of a computerized microelectrode data acquisition system according to the invention is termed “DBS Data Acquisition.” This program allows for easy input of microelectrode data regarding: the depth along the track where a particular cell is located; the corresponding structures for that cell; the type of cell; and, if applicable, the body part and type of movement associated with the particular cell or cell type.

The system features a graphical display designed to streamline data entry, with an associated subprogram that allows for simple plotting and printing of the data scaled to the proper physical dimensions. A significant advantage of the computerized data acquisition system of the invention is that it is able to eliminate the need for two people simultaneously recording and plotting the data, as is necessitated by the manual methodology in current use.

### Computerized Image Guidance System for DBS Surgery

Yet a further aspect of the invention is a computerized image guidance system for deep brain stimulation (DBS) surgery that integrates several of the above-described capabilities. Many combinations of the above-described systems are possible, and are within the scope of the invention.

One preferred embodiment of a computerized image guidance system for DBS comprises the following:

(a) a computerized system for enhancing visualization of structures in three-dimensional space in medical images of the brain of a subject, comprising: algorithms for transforming data points in the subject's medical brain images from stereotactic space to anatomic coordinates in a three-dimensional neuroanatomic brain map, and for overlaying images of the three-dimensional brain map on the subject's medical images;

(b) a computerized DBS data acquisition system; and

(c) an algorithm that permits the user to display an enhanced three-dimensional neuroanatomic map of the brain from (a) and digitized microelectrode data from the data acquisition system of (b), wherein the microelectrode data appears as an overlay on a three-dimensional neuroanatomic map of the subject's brain.

The digitally-acquired data resulting from the data acquisition system can be plotted and printed for use with a standard print atlas, or alternatively can be used with a digital representation of a brain atlas such as the Schaltenbrand-Bailey.

In order to optimize the use of the above-described digital brain map and digital microelectrode data in a clinical setting, the DBS image guidance system includes a graphical user interface (display) that allows for simultaneous viewing of the microelectrode data and the brain map images. As discussed above, a distinct advantage of the inventive systems is that the 3-D brain map can be arbitrarily sliced at para-sagittal planes that are not available in the original printed atlas, allowing the neurosurgeon to take a track trajectory that is not along the sagittal plane, and still be able to form fit the data to the atlas.

Additionally, since both the brain map and the patient data are stored in a computer, it is possible to measure how well the data is form fitted to the atlas, and even to be able to form fit the data appropriately. The system enables loading of any of the digitized atlases contained therein, and includes a transformation matrix that corresponds to the transformation necessary to morph the atlas to fit the patient MRI. The end result of this system is the ability to view the atlas at arbitrary planes and appropriately form fit the microelectrode data.

As discussed above, the inventive systems include several components that can each be run separately. However, when combined in various embodiments, the inventive systems comprise a unique system and methodology for improved targeting of anatomic structures in DBS surgery. Accordingly, the system components are designed to work together and to provide for data flow from one component to another.

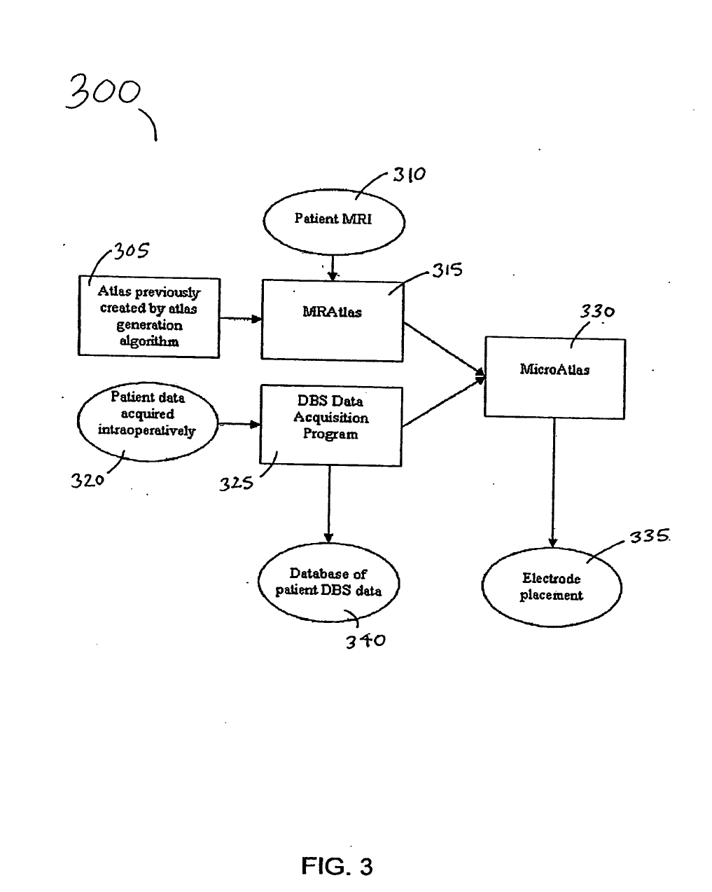

As one non-limiting example, a flow chart outlining the flow of data within an exemplary embodiment of a computerized image guidance system for DBS surgery 300 is shown in FIG. 3. More particularly, the flow chart illustrates data transfer through a system in which ovals represent data or information that is outside of the realm of the system, and rectangles represent data or information that is directly part of the system. As indicated in the flowchart, the system as a whole is interlinked, requiring data to be imported from one system to the next, starting with the use of a three-dimensional brain map (“atlas”) 305.

Using an atlas creation code further described infra, a digitized three-dimensional brain map can be created from any of the available atlas of anatomy, or from a combination of previously digitized atlases. Numerous hard copy brain neuroanatomical atlases have been published over the past century including the Co-Planar Stereotaxic Atlas of the Human Brain by Talairach and Tournoux (12), Atlas for Stereotaxy of the Human Brain by Schaltenbrand and Wahren (10), Introduction to Stereotaxis with an Atlas of the Human Brain by Schaltenbrand and Bailey (11), Referentially Oriented Cerebral MRI Anatomy: Atlas of Stereotaxic Anatomical Correlations for Gray and White Matter by Talairach and Tournoux (15), and Atlas of the Cerebral Sulci by Ono, Kubik and Abernathey (16).

The majority of the available print atlases do not have high-resolution images of the subcortical anatomic structures of interest, but two atlases in particular have been widely used and known to offer useful data in this region. These atlases, by Schaltenbrand-Wahren and Schaltenbrand-Bailey, are commonly used in microelectrode recording based procedures such as DBS, pallidotomy, and thalatomy.

Referring to FIG. 3, using the inventive system, a three-dimensional brain map 305 can be loaded into medical images from a patient, such as MRI images 310, using an atlas overlay program 315, such as MRAtlas, described infra, which allows for the scaling and translation of the atlas to fit the patient data. A transformation matrix from that result can be saved and used later in the process.

Patient data that is acquired intra-operatively, as indicated by oval 320, (e.g., microelectrode targeting data), can be acquired by the system using a computerized data acquisition system 325, implemented, e.g., by the DBS Data Acquisition program 325, described infra. The data from this program includes information required to describe the position of the microelectrode tracks in the patient's brain as well as the position of each data point and the data associated with it.

The digitized microelectrode data can be read into the atlas with a microelectrode data overlay program 330 (e.g., MicroAtlas, described infra), to display the microelectrode data and atlas simultaneously and to manually or automatically form fit the data to fit the chosen atlas. In addition, the transformation matrix from the MRAtlas program 315 can also be read into the MicroAtlas program 330, and the atlas can be transformed to better fit the patient's anatomy, providing for better and more accurate form fitting to the microelectrode data. Some embodiments of the image guidance systems 300 are further configured for outputting and storing acquired individual patient data to a database of DBS data 340 obtained from a plurality of patients.

As can be appreciated from FIG. 3, use of a computerized image guidance system for DBS surgery such as the system 300 can greatly enhance a surgical team's efficiency and ability to accurately target a brain structure of interest for functional testing, and to precisely place a therapeutic DBS electrode in a desired location in the brain of a patient (as indicated by oval 335 in FIG. 3).

### EXAMPLES

The invention is further illustrated by reference to the following non-limiting examples. In various embodiments of the image guidance system for DBS surgery, advanced algorithms are incorporated, e.g., one for digitization of an atlas to form a digitized three-dimensional brain map, and one for microelectrode track matching to the digital brain map. In addition, particular embodiments of three separate programs are described. An algorithm called MRAtlas allows for display and transformation of a MR image on atlas contours. A program termed DBS Data Acquisition allows a user to input and store digitized-microelectrode data, and a program named MicroAtlas allows for display of microelectrode data on a three-dimensional digital atlas. The following Examples provide further details of how to create and use these algorithms.

### Example 1

### Digitized Atlas of Neuroanatomic Structures

A central component of various systems and embodiments in accordance with the invention is a digitized three-dimensional brain map. This Example describes the development of a digitized version of a printed atlas of neuroanatomy suitable for use in an image guidance system for DBS surgery.

1.1 Introduction.

The Schaltenbrand-Bailey atlas has been used exclusively by neurosurgeons so this is the atlas that was chosen to be digitized. The Schaltenbrand-Bailey atlas is based on a study of 11 brains and is a collection of photographed images and contours of macroscopic and microscopic sections. Because only the myelin stained microseries, depicting subcortical structures, was of concern for the creation of the digitized atlas, only two of those 111 brains were of interest for this work.

The myelin stained microseries is composed of sections from three different cuts, i.e., coronal, sagittal, and axial. The coronal series is composed of twenty sections of the right hemisphere of brain LXVIII from a 51-year old male who died of pneumonia. The sagittal series is composed of eighteen sections of the left hemisphere of brain LXXVIII from a 40 year old male who died of pneumonia. The axial series is composed of twenty sections of the right hemisphere of brain LXXVIII from the same 40-year old male who died of pneumonia.

1.2 Methods

To provide physicians with a choice of atlases to improve targeting, two of the cuts were digitized to create separate atlas reconstructions. Since brain LXXVIII was cut in both hemispheres for the sagittal and the axial series, these cuts were reasonable to use to create two related atlases, as the data may be closely linked. The anterior commissure to posterior commissure distance is 23 mm for brain LXXVIII (11). While several other groups have digitized the Schaltenbrand-Wahren or Schaltenbrand-Bailey atlas (17-20), few groups have considered digitization of the non-sagittal sections, or attempted to combine atlas data to effectively create an additional atlas. The methods employed some approaches described by Ganser et al (21).

a. Digitization and Interpolation Algorithm

Each section depicted in the atlas is presented as a photograph of the section with a magnification of four to one with contours overlaying them that signify the region that a particular structure encloses. The first step in digitization involves physically scanning the photographs so that the resulting images can be processed on a computer. A standard high quality oversized scanner was employed to scan these atlas sections into JPEG and TIFF image files. The scanner resolution was set to 11.8 pixels/mm² and scans of the photographs were converted to a high quality JPEG image while the scans of the contour overlays were converted to a binary TIFF image. Each section has a predefined coordinate system based on the Talairach AC-PC, anatomic, coordinate system. In the case of the sagittal sections, each section has a set of axes. The horizontal axis defines the commissural line, while the vertical axis defines the mid-commissural plane. In the case of the axial sections, each section has a single horizontal axis that defines the mid-commissural plane with the most medial portion of that line defining the mid-sagittal plane.

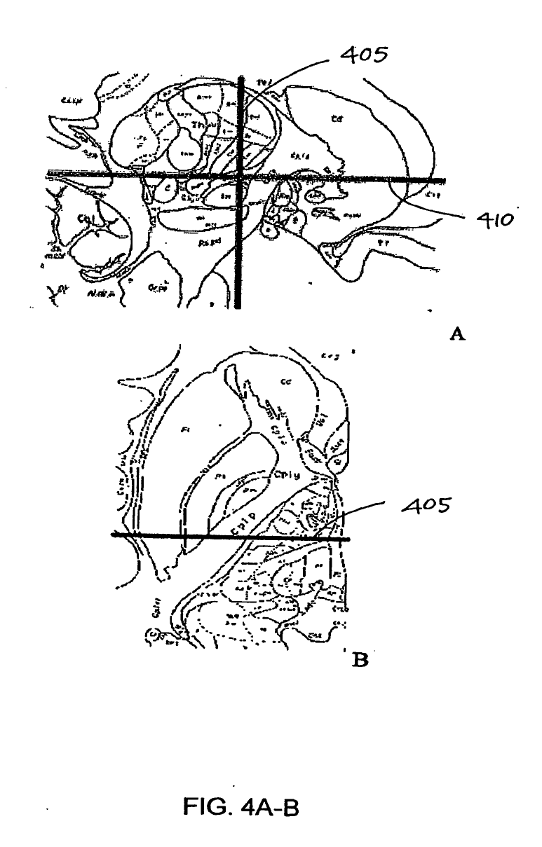

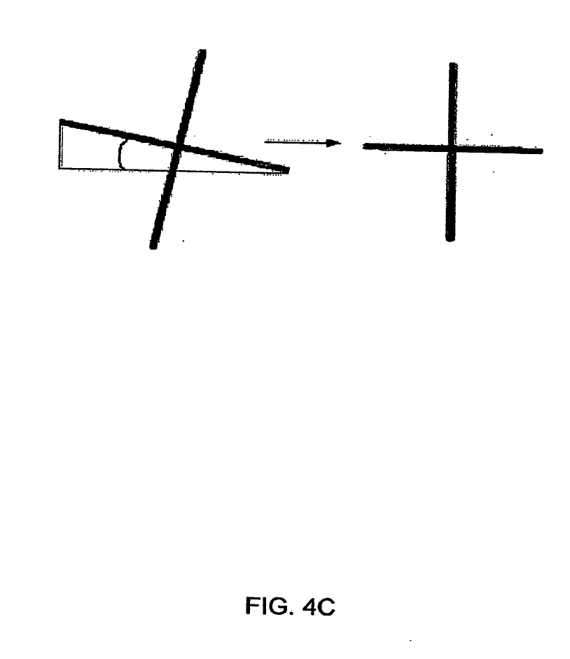

When the scanned-in sections with corresponding contours are physically scanned, the resulting images are not necessarily straight or centered. In order to correlate these contours with each other through the coordinate system, it was necessary to reorient each scanned image. For sagittal sections, this required the origin to be defined as the intersection of the axes and the horizontal and vertical axes to be rotated to achieve proper alignment, as illustrated in FIGS. 4A-C.

FIGS. 4A and 4B show typical slices through the Schaltenbrand-Bailey atlas with lines 405 and 410 designating the coordinate system FIG. 4A is a sagittal slice, with line 410 designating the commissural line, and line 405 designating the mid-commissural plane in this view. FIG. 4B is a trans-axial slice with line 405 designating the mid-commissural plane as seen in the trans-axial view. FIG. 4C is diagram showing realignment required for an atlas slice using the crosshairs, as seen in FIG. 4A. This realignment straightens the image, creating a common coordinate system among all the images. For the axial sections, the origin was defined as the right-most point along the horizontal axis and the horizontal axis angle was used to properly rotate the image (FIGS. 4A-C).

A script was created in Matlab that would read the image files and allow for selection of the origin and of the left-most and right-most points on the horizontal axis. As can be seen from FIG. 4C, the horizontal axis is realigned by the measurement of the angle it subtends with a perfectly horizontal line. The center of the image's matrix is taken to be the origin and a horizontal line is defined as a line that runs perfectly along a single row on the image's matrix. The required translation and rotation was calculated and a new centered and reoriented image was saved to a new image file.

Once each image has been scanned and properly reoriented, the structures of interest must be extracted. Since each structure in each plane is defined by a contour and there are numerous structures in each plane, each structure must be manually extracted from the surrounding structures. This extraction is accomplished by further processing of the image file. Each file was read into Adobe Photoshop™ and the structure of interest was identified and its contour selected using the “Magic Wand” tool and all other objects removed from the binary image, thereby creating an image with only the contour of the structure of interest present. The resulting image was saved as a new file identified by the corresponding structure and the plane that it was on. Matlab was used to contour each structure for each plane and the resulting set of points was stored in a matrix indexed by the plane to which it corresponded.

The creation of the axial reconstruction required the measuring of the Reid's plane angle to the AC-PC plane. Since the axial data was not created in planes parallel to the AC-PC plane, the angle from the AC-PC plane must be known to accurately calculate the coordinates for each contour in space. The angle of the Reid's plane was found to be around 6 degrees from the AC-PC plane. The corrected location for each point along a contour was then stored as previously described.

Once a set of points that defines the surface of a structure of interest has been obtained, interpolation of these points requires a definition of the connection of these points in such a way as to define a surface. The surface of these structures is typically of complex geometry, so a surface interpolation must be robust in order to accurately describe it. Other groups have solved this problem with many differing techniques with varying results, but the resulting interpolation methods typically fall into two regimes, i.e., linear or non-linear interpolation.

For the interpolation of the surface and volume of the anatomic structures of interest, a linear interpolation method was chosen. For the linear interpolation of the atlas, the method that was employed for surface determination was to connect the set of points that are along one contour to the set of points that are along the neighboring contour(s). A method to determine this connection often used in graphics and modeling is to consider a triangulation of the points of interest. Triangulation of the points determines the nature of the surface by defining the surface as the union of the faces of the set of triangles. A commonly used algorithm for triangulation is Delaunay triangulation (22), which determines the set of lines to connect a point to its natural neighbors. Applying this algorithm across the set of contours of a structure creates an interpolated surface that fits exactly along the set of contours.

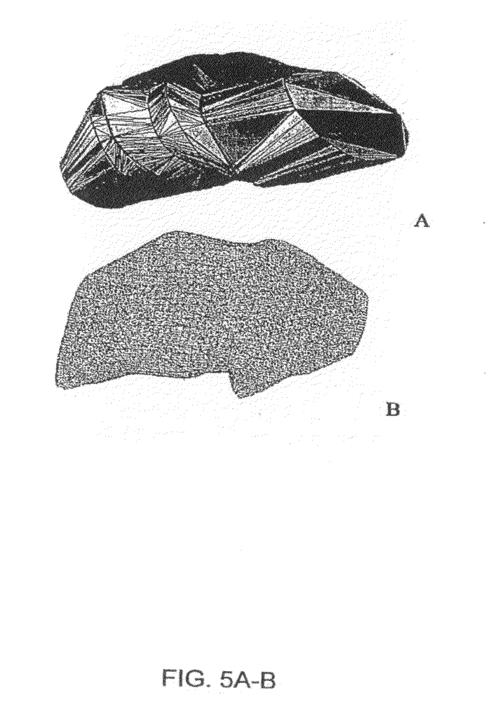

While this determination for the surface is in principle a viable solution, the linear nature of the triangulation-created surface results in an aesthetically unpleasant reconstruction as well as one that is likely to be incorrect due to inherently flawed data in the print atlas planes. As can be seen from FIG. 5A, a triangulated surface without smoothing is linear and has edges that are not differentially continuous, whereas a smoothed surface lacks these rough edges and produces a reconstruction with a more acceptable appearance. More particularly, FIGS. 5A and 5B depict surfaces of the STN digitally reconstructed from sagittal data by tessellation of contours. FIG. 5A is a polyhedral representation of the STN surface, and B is a wire mesh representation following smoothing.

A solution to this problem is to smooth the surface. To smooth the surface, a voxelization method was employed, in which a mesh of the structure of interest was first created. The chosen mesh has a voxel size of 0.25 mm by 0.25 mm by 0.25 mm, which roughly corresponds to one-half to one-third of the size of the smallest component of an anatomic structure of interest. The surface determination was then generalized to a volume determination by Delaunay tetrahedrization (23). In order to use Delaunay tetrahedrization for meshing of the structure, the set of points that correspond to each structure must also include the internal points of each contour. Accordingly, the set of internal points was included for each contour of the structure of interest by testing a rectangular region around each contour and creating a matrix of the points that correspond to the internal-points within each contour for a given anatomic structure. Since the meshing of the volume was accomplished with (0.25 mm)³ voxels, the meshing of the points within each contour also analogously needed to be completed on a 0.25 mm by 0.25 mm grid.

Once the complete set of points corresponding to the contours and the internal points of each contour have been obtained, Delaunay tetrahedrization aided meshing of the data leads to a linear interpolation of the volume. These voxels are created to have a binary intensity and thus the intensity was set as one for a voxel that corresponds to the inside of a structure and zero for a voxel that corresponds to the outside of a structure. Meshing of these structures, at first glance, creates a volume of data that is in fact more rough and aliased than the triangulated model, but smoothing of the meshed structures can be accomplished with relative ease. The smoothing algorithm was implemented by convolving with a smoothing kernel. Two different kernels were used; the kernel used for all small to medium sized structures was a Gaussian kernel with standard deviation equal to 0.5 mm, whereas the kernel used for large sized structure was a Gaussian kernel with standard deviation equal to 0.25 mm.

Larger structures typically required a greater amount of smoothing due to having a more irregular shape. Two structures that were considered to be large-sized structures were the thalamus and striatum. Upon smoothing, the mesh no longer has binary intensities, and so a new surface was determined from an isosurface at an appropriate value, around 0.5. The end result of the smoothing is able to not only create a surface that is no longer a simple linear interpolation of the initial data, but it is also able to reject some degree of artifacts in the data that are likely to be present. The smoothed result will not necessarily be a perfect fit of the original data. This algorithm was applied across the fourteen structures that were digitized and the two datasets, sagittal and axial. The described algorithm was implemented in Matlab. The final result for the data from each cut type was stored as a Matlab workspace file with an independent variable for each structure along with a corresponding matrix for the Cartesian coordinates for each voxel of that structure.

One of the issues with the Matlab implementation of the Delaunay tetrahedrization is an inherent inability to correctly interpolate concave objects. This issue is due to Matlab's usage of the QuickHull (Qhull) algorithm (24), which does not correctly consider the case of concave data. The solution used is to consider each concavity within a convex structure as a series of convex objects and to subtract out that portion of the object. For smaller concavities, this method is typically unnecessary, but for large concavities the Delaunay tetrahedrization creates artifacts within the concave region and requires the use of this alternative approach. Alternatively, a concave structure can be considered as the sum of convex objects, which is an appropriate description for branching objects as well.

b. Creation of an Atlas from a Combination of Cuts

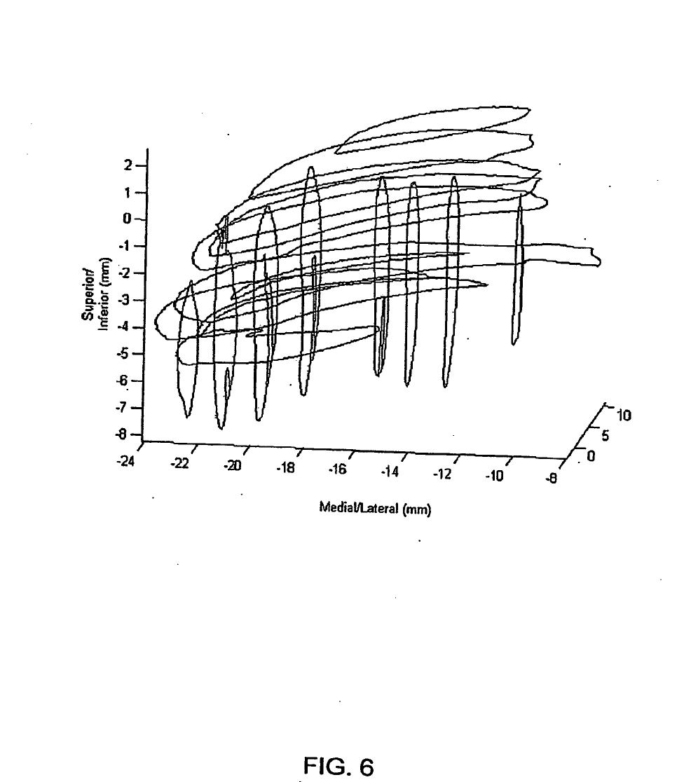

One of the immediate implications of a voxelized atlas is that combinations of atlases can be used to create a new dataset. The methodology developed to combine atlas data involves adding voxels from one dataset to the voxels from another dataset for the corresponding structure. Since two distinct cuts were digitized, two separate datasets were created that were added together to create another distinct atlas that is unique from either of the two. Whereas in the simplest case the voxel intensities of each atlas can be added together without modification of their spatial relationship to each other, this would lead to the creation of an atlas with anatomic structures that are odd in shape, and size and structures may even be entirely incorrect. For example, the GPi contours from the sagittal dataset show an inferior shift from the GPi contours in the trans-axial dataset, as shown in FIG. 6. More specifically, FIG. 6 shows a three dimensional view of unregistered GPi contours. The horizontally-oriented contours were created from the Schaltenbrand-Bailey trans-axial dataset whereas the vertically-oriented contours were created from the sagittal dataset.

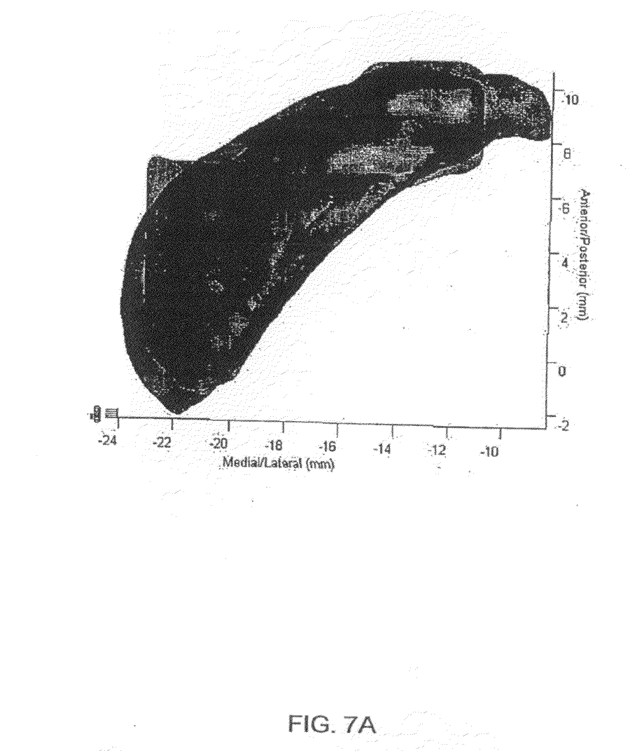

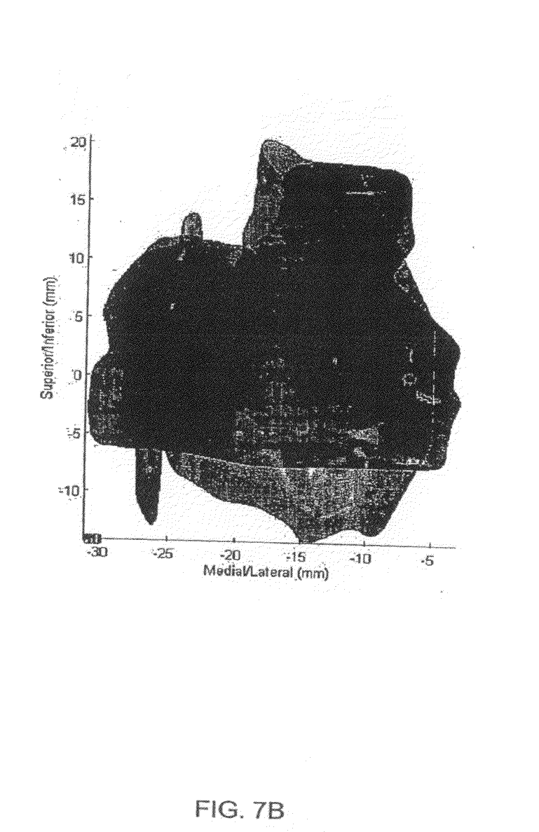

For clinical use, a preferable atlas is one that augments the shortcomings of either dataset alone. In the sagittal dataset, the data for each structure is missing at the ends of the structure, and at medial and lateral points, since there is no data beyond those sections to describe the surface of it at those points. In the axial dataset, the data for each structure is missing at the ends of the structure as well, but the missing ends of these structures are in the superior-most and inferior-most points. FIG. 7A depicts a superior-to-inferior view of digitally reconstructed and registered GPi structures. The darker-shaded volume is the reconstruction from sagittal cuts, and the lighter-shaded volume is the reconstruction from trans-axial cuts. FIG. 7B depicts a posterior-to-anterior view of digitally reconstructed and registered striatum structures. The lighter-shaded volume is the reconstruction from sagittal cuts and the darker-shaded volume is the reconstruction from trans-axial cuts.

Referring to FIGS. 7A and 7B, it can be seen that the reconstruction from sagittal cuts is shorter than the reconstruction from trans-axial cuts on the medial and lateral ends, whereas the reconstruction from trans-axial cuts is shorter than the reconstruction from sagittal cuts on the superior and inferior ends. While the majority of the structures considered of interest for DBS do not significantly suffer from this lack of data at the ends, of particular note is the lateral end of the striatum from the sagittal section reconstruction, which can be seen to extend much further lateral in the axial reconstruction (FIG. 7B).

To combine atlases in a preferred manner, each structure from the axial reconstructed dataset was registered with the corresponding structure from the sagittal reconstructed dataset, such that the volume of intersection of the two structures was maximized. The registration algorithm utilized for this purpose determines the volume in common between the two corresponding structures. The two structures are then moved in space until the volume of intersection is maximized. The resulting new atlas can be viewed in multiple ways. Since the data itself is in the form of intensities, by varying the intensity used to create the isosurface, the created surface can represent either the intersection or the union of the two datasets. For the purpose of this work, the union was used to create an additional dataset since it supplements the shortcomings of sagittal or axial-datasets alone.

c. Creation of Atlas Models

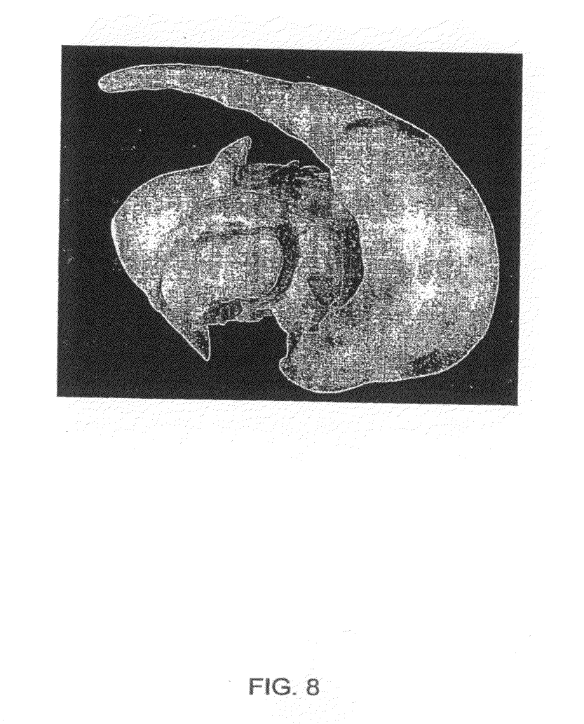

For visualization and validation of the digitally reconstructed atlas created from the print atlas, physical models of the structures were created at a four-to-one scale of the actual structures. Matlab was used to generate a polyhedral representation of each structure that was created, and a script was used to write out stereolithography (STL) files for each structure. A Z Corporation Zprinter™ was used to print out a three dimensional physical representation of each structure. An example of a physical model of the striatum, GPe, and GPi created from a Zprinter is shown in FIG. 8.

d. Atlas Validation

A set of programs and scripts was created to properly assess the error in the digitally reconstructed atlas. Two programs, Atlas Evaluator and Atlas Slicer, were created in Matlab for visual validation of the atlases. Atlas Evaluator displays an image of a chosen atlas section and the corresponding contours from which the final digital reconstruction is overlaid. Atlas Slicer allows for arbitrary planar slicing of the atlas and display of the final contour at that particular plane. By displaying the digitally reconstructed atlas on top of the print atlas, an expert can validate that the atlas is constructed correctly and that distortions in the original hard copy atlas were not inadvertently introduced. A separate set of scripts was created to automatically go through the reconstructed digital atlas at the respective print atlas planes and determine the area of intersection between the digital atlas structures and the print atlas structures. The area of intersection allows for a quantification of the validity of the generated digital structures.

### Example 2

### Development of a Clinical System for Deep Brain Stimulation

This Example further describes several novel computer programs suitable for use in positioning stimulation electrodes in an image guided DBS system in accordance with the invention, and the development of a clinical system for DBS, based on these programs.

2.1 Overview

A set of computer programs with graphic user interfaces was created in Matlab to implement clinically useful viewing of the atlas and microelectrode data. More specifically, a program, named MRAtlas was created to view MR images with contours of the atlas superimposed on them. Another program named DBS Data Acquisition program was created to intraoperatively obtain microelectrode data for display and plotting purposes. A final program, MicroAtlas, was created to view the acquired microelectrode data on the superimposed atlas contours. These programs together provide a framework for clinical implementation of the improved DBS guidance system, and are further described in detail infra.

2.2 MRAtlas Program

The MRAtlas program is a graphical user interface aimed at improving the initial MR image targeting and the microelectrode data form fitting. The program itself enables the user to load Digital Imaging and Communications in Medicine (DICOM) images of a particular patient along with an atlas of images previously created in the format mentioned. MR images are obtained by using a stereotactic system to create raster images from CT fused MR images. These raster images are converted to a DICOM series and read into the MRAtlas program. Once a MRI and atlas have been loaded, the program loads the MRI into three orthogonal views of the patient's brain: i.e., sagittal, coronal, and axial. The user can then define the anterior commissure, posterior commissure, and a central point along the mid-sagittal plane of the brain by either setting the points through the user interface and clicking on the points to be defined, or by entering in these points manually. The definition of these three points defines an anatomically based coordinate system on the patient's brain. The coordinate transformation from stereotactic space to this anatomic coordinate system is defined as described below.

Once these points have been defined, a user has the option to realign the patient's brain in this coordinate system by choosing “Anatomic View Enable.” To speed up the transformation and reinterpolation of the MRI data into the anatomical coordinate system, a C language-compiled MATLAB Executables (mex) file was created.

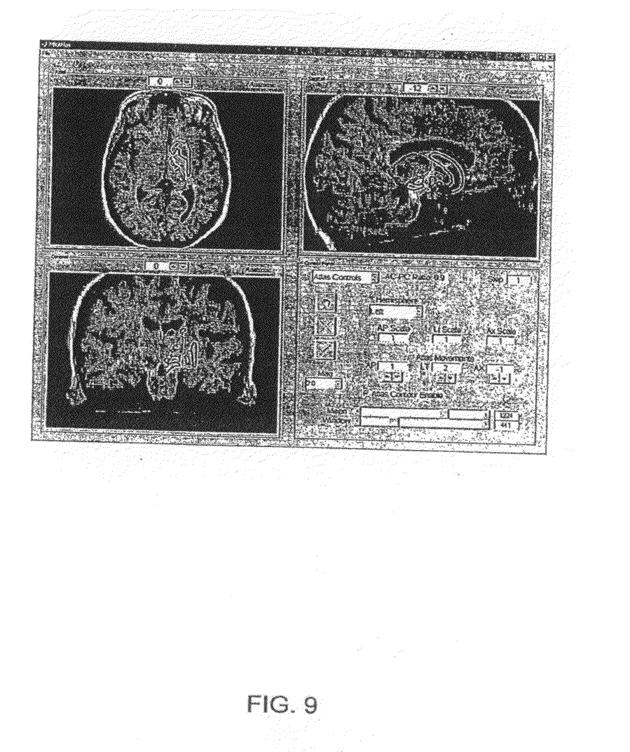

Following realignment of the patient's brain to anatomic coordinates, the loaded atlas can be overlaid on the patient's MRI, as shown in FIG. 9. More specifically, FIG. 9 shows a sample MR image with fitted atlas contours taken from the MRAtlas software. The atlas can be scaled and translated to better fit the patient's anatomy using the controls in the user interface. The available options for scaling allow the user the ability to translate or scale the atlas to fit either hemisphere of the patient by choosing the anterior-posterior scaling, medial-lateral scaling, axial scaling, and their respective translations. Scaling and translation of the atlas are accomplished by transforming the stored matrices that correspond to the Cartesian space location of each voxel in the atlas. The program allows the user to write out the transformation matrix for research purposes, or to transform the atlas to fit the microelectrode data.

2.3 DBS Data Acquisition Program

The DBS Data Acquisition program was developed to replace traditional manual systems of writing and plotting microelectrode data points that require two users. In such approaches, two users sit side by side for microelectrode data acquisition and plotting. One user enters microelectrode data into a data entry form and the other user manually creates plots using the entered data.

To streamline this aspect of the DBS procedure, the invention provides a user interface created in Matlab for quick data acquisition and printing of the microelectrode data as well as other necessary data for research purposes. In a preferred embodiment, the program comprises several subprograms, including: a main patient information form; a track information form; a Unified Parkinson's Disease Rating Scale (UPDRS) form; a Tremor Rating Scale (TRS) form; a targeting form; a microelectrode data entry form (non NIH-study); a microelectrode data entry form (NIH-study); a plotting and printing routine; and a macrostimulation form.

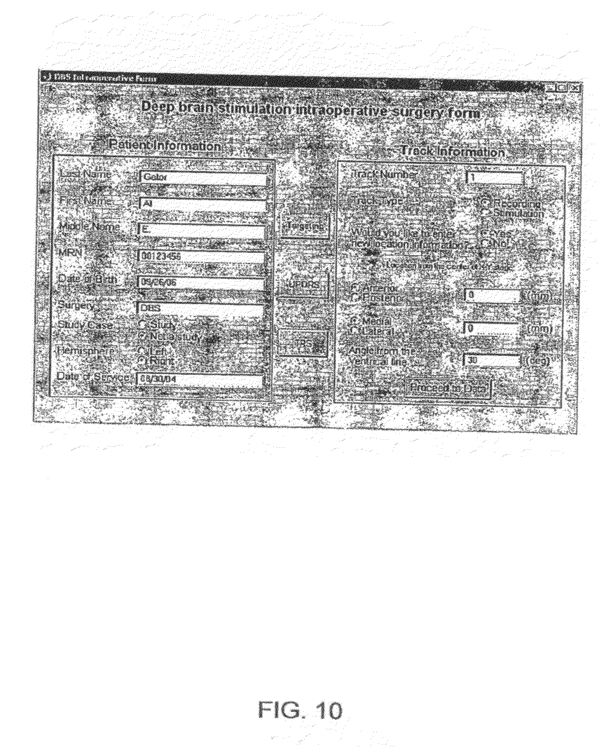

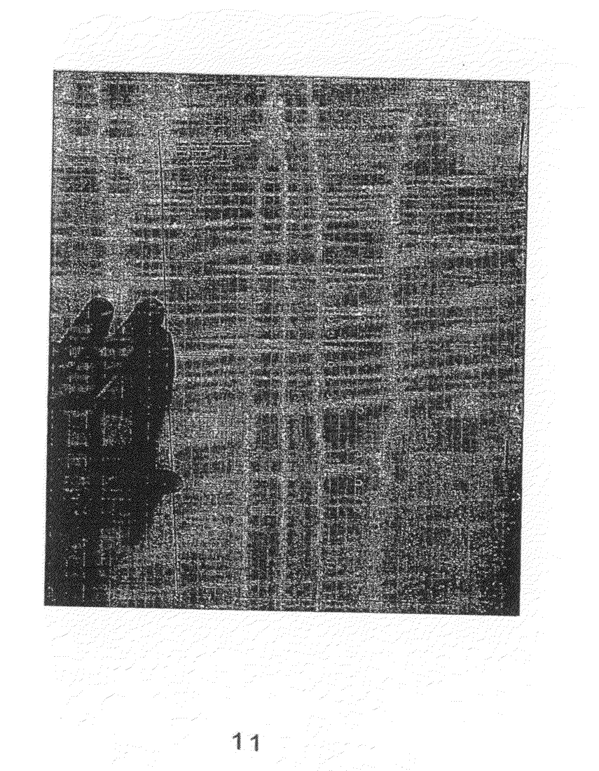

The main patient information form is first used to input patient information related to the particular-DBS procedure being performed. An example of a patient data entry screen from the DBS Data Acquisition program is shown in FIG. 10. Once this data has been entered, the user must define two save locations, one save location corresponding to a place on the computer's hard drive and the second save location specified to an external location. Since the data from the microelectrode tracks is mission critical, it is extremely important that safeguards be in place to prohibit data loss in the event of a computer failure. For this reason, the capability of multiple save locations is an advantageous feature of this system.

The user can then enter UPDRS or TRS data and targeting data. The targeting data must be accurately entered, as it is used in the MicroAtlas program to determine the coordinates of the tracks and data points relative to the atlas. Once those data are entered, microelectrode data can be entered in either the study or the non-study data entry form. The NIH-study form does not refer to particular structures, as the target for the stimulation is blinded, whereas the non-study form has a large number of choices for structures that may be seen during DBS.

Once the information relative to the particular track of interest has been entered, the data contained within the track can be entered with either the microelectrode form or the macrostimulation form. The microelectrode data form is a somewhat complicated form, as it needed to satisfy the complexity of numerous options for data entry with the simplicity necessary to quickly enter data points as they are being determined by a physician. Towards this end, a form that displays all available options with large easy-to-select buttons was developed. The available options include the depth along the track; the site or time of the cell as well as the quality of the recording; the cell location; the cell location certainty; the cell type; and (if applicable) the corresponding body part location and movement.

The options for locations in the non-study form are: striatum; thalamus; Voa; Vop; Vim; Vc; STN; SNr; GPe; GPi; ansa lenticularis; ZI; internal capsule; optic tract; border; nucleus accumbens; quiet; fiber; top; bottom; and other. There are twenty-one of these locations, of which a majority has been included in a previous digitization of the printed Schaltenbrand-Bailey atlas (11). Alternatively, the locations can be specified by colors for the purpose of maintaining secrecy in a blinded research study. The location can also have an associated certainty or lack thereof designated as either “Certain” or “Uncertain” in the program. In addition, each of several cell type designations is included in the user interface including: unidentified negative potential (Neg); injury; popcorn; bursting; pausing; high frequency discharge (HFD-P); low frequency discharge (LFD-P); chugging; low amplitude; high amplitude; tactile; light touch; rhythmic; oscillatory; tremor, proprioceptive active; proprioceptive passive; tonic; background up; background down; and other.

For cells of the tactile, light touch, proprioceptive active or passive cell type, an option is given to allow the user to choose a particular body part location associated with that cell type and (if applicable) a corresponding movement of that body part location that evoked a signal. The body part location options are: face; cheek; inner mouth; tongue; jaw, chin; neck; shoulder; elbow; arm; hand; wrist; fingers; hip; leg; knee; ankle; foot; and toes. The corresponding movements are: abduction; adduction; extension; flexion; internal rotation; external rotation; dorsiflexion; and plantarflexion.

The user must input a reasonable value for the depth (greater than zero and less than one-hundred) and location and location certainty, while other fields are optional. Once the depth and other associated data has been entered, the user should enter the data as a data point in the program by clicking on the “Enter Data” button. The program will store the data into a matrix and create an auto save file. The auto save feature is a redundancy feature that saves an instance of all the data to a new file at both specified save locations.

Because the microelectrode data acquisition process is time-consuming, the user may not save data often enough, and in the case of a computer failure, data would be lost. Advantageously, the auto save feature overcomes this issue by forcing an auto save file, designated as autosave-“timestamp”.dbs where “timestamp” is the time at which the data point was entered, to be created for each point of data entry. The auto save feature itself is triggered every time the “Enter Data” button is pressed. Another component of this program includes a display that shows these data in a tabular format and allows the user to select and modify data points as necessary. In addition, another component of this program allows entry of microstimulation data. An interface was created that allows the user to select the depth at which stimulation occurred, as well as the type of stimulation (electrical or light, if applicable); the current of the stimulation; and the response to stimulation (positive or negative). If light stimulation evokes a positive response, an optic tract point is put into the microelectrode track data.

Once an entire track of data has been completed, the user may choose to plot or print the data from this track, as well as multiple other tracks. A plotting subprogram with a graphical user interface allows the user to select those tracks to be plotted, and once a plot is created, to print those tracks out. An example print out of microelectrode data from the DBS Data Acquisition program is shown in FIG. 11. Due to the complex nature and the fact that the data corresponds to points in three dimensions, printing out the data to be form fit requires that the data be properly printed, to ensure that all the necessary data is present in an easy-to-read format. A preferred method is to print from a standard color printer onto legal-sized paper or transparencies. In studies performed by the inventors, the data was printed at a scale of ten-to-one so that it could be form fit to the intraoperative copy of the Schaltenbrand-Bailey atlas in the operating room, the scale of the atlas being ten-to-one.

Each point in the data entry process is plotted and given a distinct color based on its cell location, and a distinct symbol based on its cell type. Special cell locations and types also have text that is plotted next to the point. An Excel spreadsheet was created that is read in by the plotting subprogram to determine what colors and symbols are needed for particular points. Accordingly, each cell location and type can be given a distinct color and symbol that can be changed to suit future needs by simply modifying the Excel spreadsheet.

Other clinical information related to the patient's tremor rating during the course of the procedure and results from the macrostimulation, or DBS stimulation electrode are also recorded in the program to provide a unified source of data related to the intraoperative procedure. Upon completion of the operation, the entire collection of information recorded from this program is saved to a Matlab workspace file but can be exported as an Excel spreadsheet from an option in the program. The complete report of data from the procedure in Excel spreadsheet form can be printed out for viewing, as well as input into a database at the institution where the DBS surgery is performed. Once the data has been entered into the database, query capabilities allow future researchers to search through the data for any pertinent information. The invention also includes a user manual for introducing users to the DBS Data Acquisition program.

2.4 MicroAtlas Program

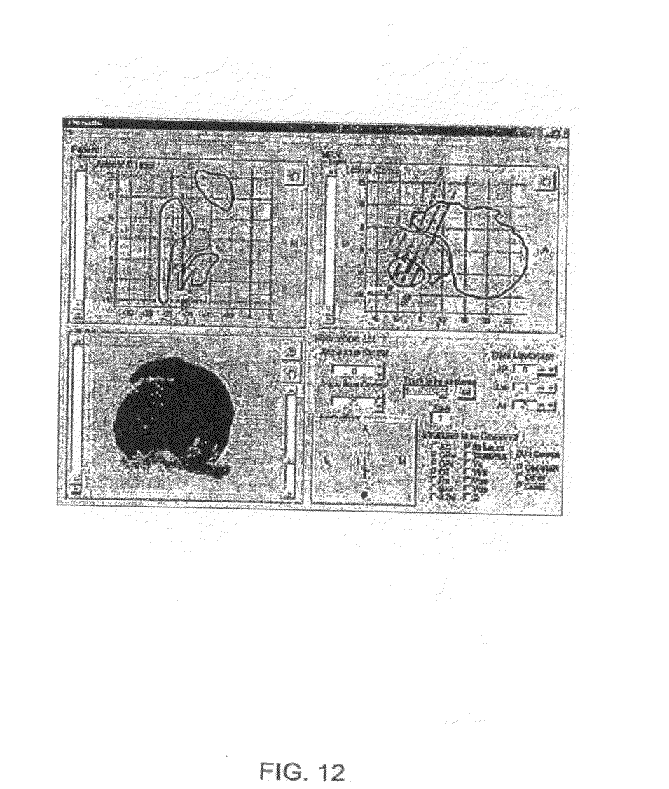

The MicroAtlas program solves a final limitation still present from implementation of the DBS Data Acquisition system itself by eliminating the need for physical printing of the microelectrode data. This additional graphical user interface program was created to facilitate viewing of the digitally reconstructed atlas superimposed with the digitally acquired microelectrode data Referring to FIG. 12, a screenshot of the MicroAtlas program is presented. The program is used to display microelectrode data as seen by the depicted lines of points. The program allows the user to load any of the previously created atlases, the patient microelectrode data, the associated patient atlas transformation matrix, and (if applicable) the microelectrode track data transformation matrix to form fit the atlas. Once the microelectrode data and atlas have been loaded, the user interface has three views that allow the user to visualize the atlas and data.

The tracks all lie parallel to each other and are generally angled in the anatomical coordinate system in a way specified by the head ring arc angle and collar angle. The transformation from the anatomical coordinate system to the coordinate system of the tracks is described below. Because each track of data is typically on an angle from the sagittal and coronal planes, perfectly sagittal or coronal views would not be helpful for visualization. Similarly, an axial view would not necessarily be helpful either, as the data along an axial cut would only be one point from each track. Therefore, the program is designed with three views in mind, i.e., a para-sagittal view; a para-coronal view; and a three-dimensional view showing the entire atlas and all of the tracks. The para-sagittal view shows a para-sagittal cut along the atlas that is on the plane of a chosen track and displays all track data that lies along that plane. Analogously, the para-coronal view shows a para-coronal cut along the atlas that is on the plane of the same chosen track and displays all track data that lies along that plane. The third view is a three dimensional view of the atlas with the superimposed tracks running through the atlas.

The tracks start at an initial position dictated by the targeting coordinates provided from the DBS Data Acquisition program. The para-sagittal and para-coronal cuts can be chosen to be centered on any track by selecting a particular track in the user interface. The tracks can be manually moved for form fitting by inputting the anterior-posterior, medial-lateral, or axial movement of the track or automatically form fit by a developed algorithm, as described below. As the tracks are moved in space, the cut along the atlas follows the track that is centered in the two orthogonal views (para-sagittal and para-coronal). Any of the fourteen digitized structures mentioned above can be chosen to be displayed, or not displayed, by a toggle switch in the user interface.

2.5 Automated Matching Algorithm

An automated form fitting or matching algorithm of the microelectrode data to the atlas was developed to supplement the subjective procedure of manual form fitting. The nature of the microelectrode data is intricate, as it has many descriptors for each point, which makes fitting the data to the atlas a unique challenge. The data acquired during a typical deep brain stimulation microelectrode track is a matrix of data with each row designating position along the track and its corresponding structure in the patient's brain. In addition, since the determination of the structure that a waveform or sound corresponds to is not necessarily clear cut, a measure of uncertainty should be considered. The automated matching algorithm was conceived in two portions: the first portion was the development of a scoring of how well the data fit to the atlas, whereas the second portion was the determination or search of the best score.

The small number of tracks and relatively few data points along each track necessitate an algorithm unlike image registration algorithms in which the relative quality and quantity of data is similar between the data sets. A typical track will have data points that correspond to between zero and four structures in the atlas that are along its path. In an optimal situation, the set of data points will contain the boundary of each structure. Unfortunately, in typical or particularly poor data situations, the set of data points may not contain the boundary and may only contain the points internal to a structure. For this reason, this algorithm makes no assumption that the set of data contains the boundary, and so boundaries are considered in an implicit and not explicit sense. A score for each point in the set of data is given as follows:

+1 is given to a data point whose location in anatomic coordinates puts the point within or on the boundary of its corresponding structure and whose location certainty was determined to be certain,

+0.5 is given to a data point whose location in anatomic coordinates puts the point outside of its corresponding structure and whose location certainty was determined to be uncertain,

−0.5 is given to a data point whose location in anatomic coordinates puts the point outside of its corresponding structure and whose location certainty was determined to be uncertain, and

−1 is given to a data point whose location in anatomic coordinates puts the point outside of its corresponding structure and whose location certainty was determined to be certain.

Analogously, a point whose location designation was determined to be “quiet,” i.e., a point whose waveform or sound was determined to not correspond to a structure, is scored as follows:

+1 is given to a “quiet” point whose location in anatomic coordinates puts the point outside of any structures whose waveform or sound could potentially be recognized and whose location certainty was determined to be certain.

+0.5 is given to a “quiet” point whose location in anatomic coordinates puts the point outside of any structures whose waveform or sound could potentially be recognized and whose location certainty was determined to be uncertain

−0.5 is given to a “quiet” point whose location in anatomic coordinates puts the point inside or on the boundary of any structures whose waveform or sound could potentially be recognized and whose location certainty was determined to be uncertain

−1 is given to a “quiet” point whose location in anatomic coordinates puts the point inside or on the boundary of any structures whose waveform or sound could potentially be recognized and whose location certainty was determined to be certain

A “quiet” point, in this scoring methodology, is a point for which no discernible sound is recorded and is thus outside a majority of the anatomic structures of interest. Once a score has been given to each data point with a corresponding structure in the digital atlas, these scores are summed up for all data points along each track. The score is normalized by dividing it by the total number of points that were scored. Accordingly, the optimal score for the data with a perfect match to the atlas would be one, whereas the score for an extremely poor match would be negative one.

The score itself is simple to assign if it is known whether a point is inside or outside a structure. The testing of any point in space and subsequent determination of whether or not it lies within a particular region is known as point classification. For this algorithm, the point classification method employed utilizes the fact that a separate matrix was stored for each structure and only tests within that small volume. The test itself involves interpolating the structure for a particular microelectrode data point at its anatomical coordinate. If that interpolated value is greater than or equal to the intensity cut off value for the boundary of the structure, then the data point is considered to be inside or on the boundary of the structure. If that interpolated value is less than the predetermined value for the boundary of the structure, then the data point is considered to be outside of the boundary of the structure. Analogously, “quiet” points can be tested by testing each structure to determine if the corresponding anatomical coordinate is within the structure, and scoring as previously described.

The second component of this algorithm involves a search of the score space to find the best match. The most thorough search involves a direct gridded search of the solution space across all possible movements that the tracks can make. While this search can be used, it may prove to be computationally intensive depending on the search grid. The search increment at which to search should be on the order of 0.25 mm as the atlas was created with 0.25 mm voxels and any much smaller increment may not produce significantly different results. An alternative algorithm used is to search along a line in each direction at a larger increment, such as 2 mm, then continue to decrease the increment and search on a line in each direction until the search increment is 0.25 mm. Once the search increment is 0.25 mm, a small volume direct search can be utilized to capture all viable solutions. The result of this algorithm is presented to the user in the MicroAtlas graphical user interface.

2.6 Exemplary Clinical Computer System

A clinical computer system in accordance with the invention was housed in a large wheeled cart to facilitate transport between the University of Florida's Movement Disorder Center and the Shands Teaching Hospital. The computer system itself is a Dell Optiplex GX280 with a Pentium 4 3.0 GHz processor and 1 gigabyte of memory. The large amount of memory is optimal in order to be able to display the atlas and MRI simultaneously in the Matlab environment A universal serial bus (USB) external hard drive was used for back up storage, as mentioned previously, during microelectrode data acquisition and a Hewlett Packard color DeskJet was used for printing of the data for manual form fitting. A 15 inch touchscreen monitor was used to expedite data acquisition through the graphical user interface. A larger monitor (19 inch) was added for use of the MRAtlas and MicroAtlas programs by the neurologist and neurosurgeon.

### Example 3

### Evaluation of Clinical System for DBS

This Example describes methods used to verify the algorithms and systems developed in accordance with the invention.

3.1 Overview

The Examples above describe the creation of the systems and development of algorithms used to improve the targeting in DBS. Verification of the algorithms and systems was completed using both qualitative and quantitative methods. The two algorithms that required validation are the atlas creation and microelectrode data matching algorithms. Qualitative verification of the atlas consisted of viewing of the atlas slice-by-slice along the planes of the print atlas, using the Atlas Evaluator program, and using the Atlas Slicer program. The automated microelectrode data matching algorithm results can be viewed using the MicroAtlas program and was subjectively evaluated by comparing to manual matching or form fitting. The results shown in this Example are for analysis of the systems described above.

3.2 Evaluation of Digitized Atlas

It is known that due to necessary voxelization of the data, interpolation, and smoothing, the created digitized three dimensional atlas is not a perfect representation of the print atlas. While the Delaunay tessellation algorithm used to determine the surface could potentially exactly represent the data in the print atlas planes, the voxelization of the structure only approximates the data. In addition, the smoothing process makes the binary digital voxelized atlas have smoother boundaries than the original dataset. Thus, two steps were taken to evaluate the atlas. First, the intensity cut-off value that defines a structure must be determined. Second, the atlas must be evaluated using this cut-off value to determine how accurate the smoothed digitized atlas is, compared to the respective planes in the print atlas.

The smoothing used convolves the binary matrix of the structure with a Gaussian kernel. The cut-off value used to designate the boundary of a structure was determined using three methods: an initial value determined from analysis of a test cube; a qualitative evaluation of the effect of the change of the cut-off value using the Atlas Evaluation program; and a quantitative analysis of the effect of the intensity cut-off value on the resultant area of the structure.

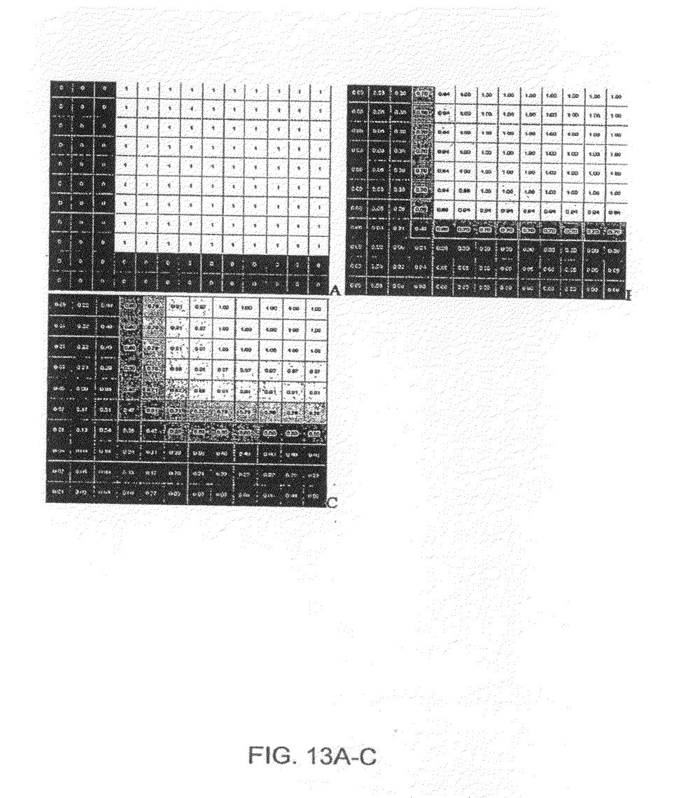

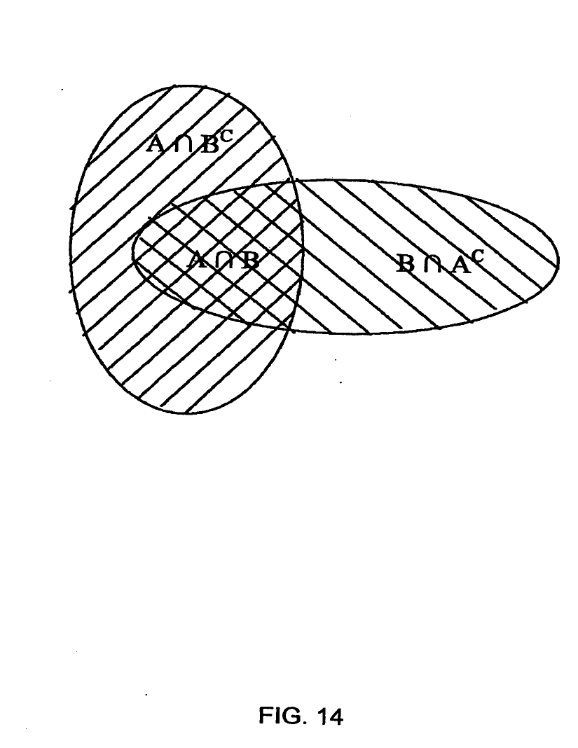

For the initial value determination, a 49×49×49 voxel cube was created and smoothed as previously described. FIG. 13 shows an edge of a square taken from a middle cross-section taken from the cube, and the effect of smoothing. More particularly, FIG. 13 shows a portion of a middle cross-section of intensity data from a 49×49×49 voxel cube. FIG. 13A shows results without any smoothing and is a binary image. FIGS. 13B and 13 C were smoothed with a Gaussian kernel with a standard deviation of one voxel and two voxels, respectively.

In the case of an unsmoothed structure (as in FIG. 13A), the linearly interpolated value at the boundary of the cube is 0.5. The interpolated intensity value at the boundary of either of the smoothed cubes was found to be 0.5 as well. Smoothing with a Gaussian kernel with a standard deviation equal to one voxel, 0.25 mm, the intensity at a boundary along the edge of the cube varied between 0.3 and 0.7 within 0.125 mm of the actual boundary, and between 0.18 and 0.82 within 0.25 mm of the actual boundary (FIG. 13B). Similarly, smoothing with a Gaussian kernel with a standard deviation of two voxels, 0.5 mm, intensities of 0.4 and 0.6 were within 0.125 mm of the actual boundary and intensities of 0.31 and 0.69 are within 0.25 mm of the actual boundary (FIG. 13C). Since the structures in the atlas are not the shape of a cube, these results are not entirely representative. The intensities at the boundaries drop off quickly to zero, so most intensity cut-off values between zero and one may produce reasonably accurate descriptions of the boundaries of the respective structures.

The sagittal reconstruction of the GPi was examined to quantitatively determine the effect of the intensity cut-off value. Since the GPi is of an ellipsoidal shape, the results may not be the same as in the case of the cube. In the case of the cube, the intensity cut-off value that exactly represents the boundary of the cube was found to be 0.5. Areas of intersection between the print atlas structures and digital atlas structures were calculated to quantitatively determine the difference between the reconstructed atlas and the print atlas.

Referring to FIG. 14, a diagram depicting the intersection of areas of interest is shown. More particularly, FIG. 14 is a Venn diagram schematically representing atlas structures. In the drawing, area A represents a print atlas structure whereas area B is a digital atlas structure slice through the same plane.

A∩BC is the region with only lines going from the lower left to the upper right.
B∩A^{C} is the region with only lines going from the upper left to the lower right.
A∩B is the region with lines that intersect. Three areas were calculated, i.e., the area of intersection, A∩B; the area in A that is not in the intersection of A and B,
A∩B^{C}; and the area in B that is not in the intersection of A and B, B∩A^{C}; where A is a print atlas structure and B is a digital atlas structure in the same plane.

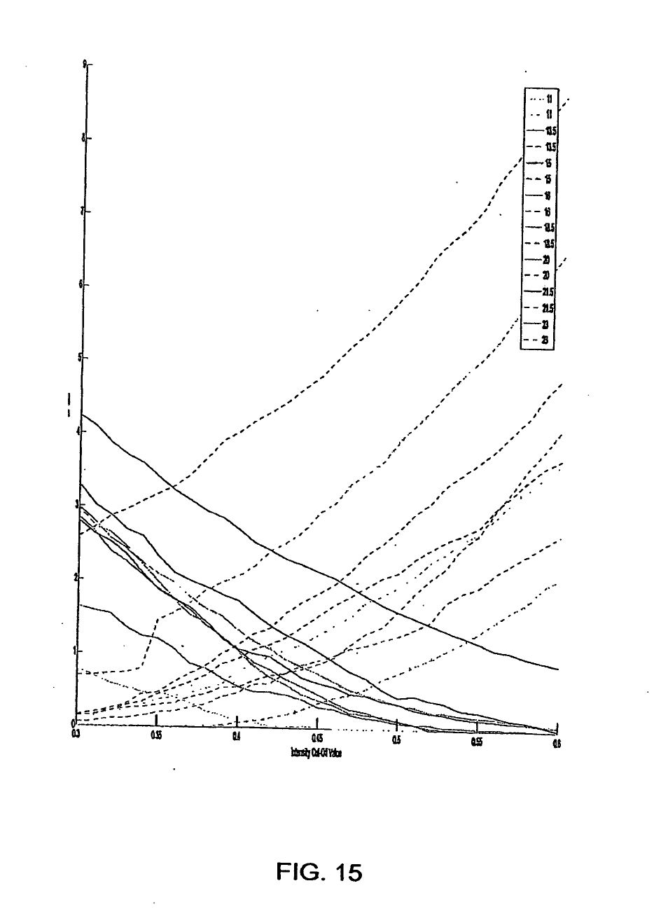

FIG. 15 shows area of slices (in mm³) through the sagittal reconstruction of the GPi that are not in the intersection-of-the-reconstructed atlas with the print atlas planes with varying intensity cut-off values. Referring to FIG. 15, the dotted lines represent A∩B^{C}, and the solid lines represents B∩A^{C} (as given by FIG. 14). In a color representation of FIG. 15, each color represents a different slice through the GPi, as indicated by the legend in the drawing.

As can be seen from FIG. 15, the optimal intensity cut-off value for any plane is not necessarily 0.5. Optimally, the dotted line and the solid line for all colors should be zero, as that would represent that the intersection of the print atlas slice and the digital atlas slice are exactly equal (A=B), and thus A∩B^{C} and

B∩A^{C} would be the null set. Due to the effects of smoothing and voxelization, the reconstructed slices are not exactly the same as the equivalent slice in the print atlas. This effect, while seemingly unwanted, provides some necessary rejection of irregularities and errors that are known to exist within the print atlases. Smoothing has the greatest effect on the planes at the sides of the structure, in this case at 11.0 mm and at 23.0 mm. Since smoothing curves the edges, the planes at 11.0 mm and 23.0 mm tend to become smaller as they are smoothed out.

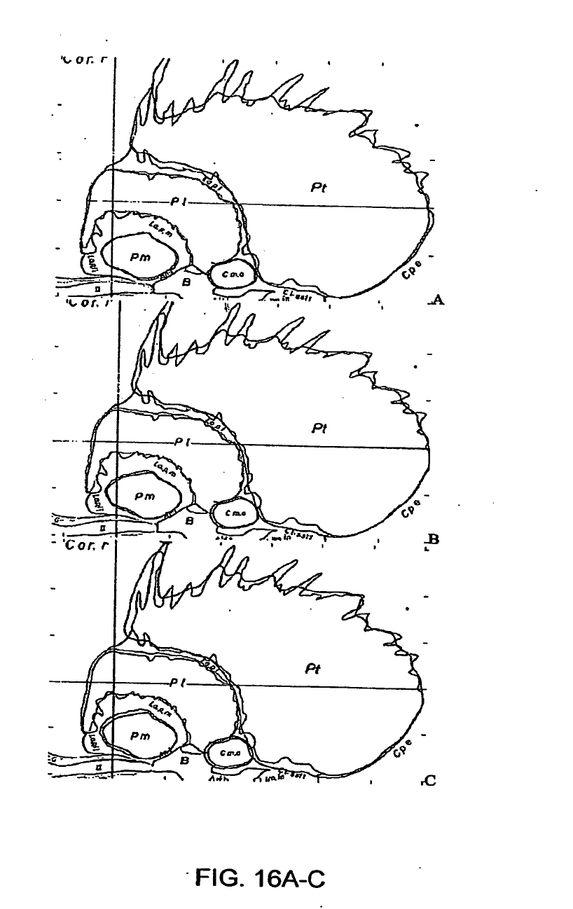

The effect of the cut-off value was examined quantitatively, as seen in FIG. 15, and qualitatively with the Atlas Evaluator program, as illustrated in FIG. 16. More particularly, FIGS. 16A-C are three drawings showing Schaltenbrand-Bailey sagittal atlas plane 23.0 mm overlaid with contours from the digitally reconstructed atlas created from sagittal contours. FIGS. 16A, B, and C use an intensity cut-off value of 0.5, 0.4, and 0.3, respectively. Values that were less than 0.5 were chosen as the intensity cut-off value, as these values were found to best model the structures. As noted previously, only particularly small or large values have a marked effect on the accuracy of the boundary. As can be seen from FIG. 16, the intensity cut-off values in the range of 0.3 and 0.5 do not seem to drastically alter the shape and size of the structures, but do show a noticeable effect on accuracy of the boundary. All sections of the axial and sagittal cuts in the Schaltenbrand-Bailey atlas with contours taken from the digitally reconstructed atlas using the determined intensity cut-off values were evaluated. Each slice was taken from the Atlas Evaluator program, which allows for the user to display the digitally reconstructed atlas and compare it to the corresponding slices in the print atlas. The effect of smoothing varied slice-to-slice and from structure to structure. Since greater smoothing was used on the thalamus and striatum, there is a noticeable difference in the shape of those structures. The voxelization of the atlas, in addition, limits the size of the smallest distinguishable component of a structure. An example of this effect could be viewed on sagittal atlas planes 21.5 mm, 23.0 mm, and 24.5 mm, for example, where it was evident that the protrusions of the striatum were not present due to their small size.

Three atlases were created, two of which were direct reconstructions from atlas print planes and a third one was created from the combination of those two. The third atlas was, as previously discussed, created from the movement of the axial anatomic structures into best fit positions of the corresponding sagittal anatomic structures. An example registration of the GPi structures can be seen in FIG. 17. FIG. 17 shows a three dimensional view of registration of GPi structures. In color representations of FIG. 17, red volumes are reconstructed from sagittal sections and blue volumes are reconstructed from the trans-axial sections. FIG. 17A shows the unregistered structures and FIG. 17B shows the effect of registration.

The distances found to best fit axial anatomic structures into corresponding sagittal anatomic structure positions are listed in Table 1. From Table 1, the method of determining the best fit positions seemingly yields highly variable results from structure to structure. The method used to register the corresponding anatomic structures seems to be more effective with larger more irregularly shaped structures. Since the sagittal and axial Schaltenbrand-Bailey atlases were created from the different hemispheres of the same brain, it may not be expected that large distances would be necessary to align the respective structures. Therefore, certain results from Table 1 seem anomalous. There are suspicious registrations for the smaller structures such as the Vim, Voa, and Vop. There were only two axial print planes for the optic tract and so the sagittal reconstruction of the optic tract is potentially much more accurate as there is insufficient data to accurately describe the optic tract. Thus, it is expected that the simple type of registration used may not yield entirely accurate results for these structures. In the pallidal and striatal region, there seems to be a consistent shift in the axial direction of around −1.5 to −2.0 mm and 1 mm in the AP direction (see Table 1 and FIG. 17).

Referring to Table 1, the thalamus and Vc appear to have a consistent shift of around 1 mm axially, −1 laterally, which is not found for Vim, Voa, and Vop potentially due to poor registration. It should be noted that the combined atlas, while potentially able to have some of the information content of both the sagittal and axial atlas, is not consistent with either the sagittal or axial print atlas. The future value of the combined atlas should be studied by comparison with known patient data of these anatomic structures.

TABLE 1
Distance required to register the following anatomic structures.

| Anatomic Structure | AP (mm) | Lateral (mm) | Axial (mm) |
|---|---|---|---|
| Anterior Commissure | −0.5 | 2.59 | −0.91 |
| Globus Pallidus Externa | −1.31 | −0.51 | −1.56 |
| Globus Pallidus Interna | −1 | −0.09 | −1.4 |
| Optic Tract | −3.75 | −0.1 | −0.93 |
| Red Nucleus | 0.63 | 0.21 | −0.9 |
| SNr | −2.4 | −2.05 | 0.8 |
| Subthalamic Nucleus | −1.1 | −0.29 | −0.29 |
| Striatum | −0.8 | −0.59 | −2.05 |
| Thalamus | −1.61 | −0.97 | 1.19 |
| Vc | −1.91 | −0.9 | 0.9 |
| Vim | −1.52 | −0.91 | 3.4 |
| Voa | −2.3 | −2.28 | 0.93 |
| Vop | −2.49 | −1.26 | 1.41 |
| Zona Incerta | 0.47 | −0.07 | 1.29 |

Distances correspond to movements of the axial structure to fit the corresponding sagittal structure.

While the atlas is not a perfect reconstruction of the print atlas data, it is able to maintain the large-scale features of the respective structures. Since even a perfect reconstruction of the structures may not be an accurate representation of a particular patient's anatomy, the smoothed results may end up producing a more consistent representation while not entirely accurate to the original printed atlas.

On top of the two print plane reconstructions, a third atlas was created that overcomes some of the limitations of the data in each atlas. While none of these atlases may perfectly represent patient anatomy, the choices available increase the likelihood for a better fit. In addition, with the MRAtlas program it is possible to superimpose the atlas on top of the patient's MRI to determine how well the atlas represents the patient's anatomy. Thus, the atlas can be made to better fit the patient's anatomy, or at least be useful in determining differences between the atlas and the patient's anatomy.

3.3 Evaluation of MicroAtlas Program for Automated Track Matching

The MicroAtlas program allows for automated track matching to the chosen atlas using the algorithm described supra. A typical manual match of tracks to the printed atlas can only be considered on the planes which exist in the print atlas. For this reason, the methodology used to manually match or form fit using the MicroAtlas program is different from the print atlas matching paradigm. Implicit in the print atlas matching methodology is an inaccuracy due to matching only in available print atlas planes, so the results of matching in the print atlas will innately be different from both the digital atlas manual and the automated matching cases. Therefore, a comparison of matching results using only the digital atlas was completed. A few sample microelectrode data tracks from previous patients were manually matched to the digital atlas and compared with automated matching results.

Results of manual and automated matching of microelectrode data to the non-deformed digitally reconstructed atlas created from sagittal sections are shown in Table 2. Matching results were completed post-operatively, only taking into account the data and so provide only an estimate of a possible manual match. Since the manual matching process is subjective, matches can vary from time to time and from person to person. As can be seen in Table 2, the deviation of automated matches to manual matches is typically 2.5 mm, in each direction, and less for the data considered. Of note is that due to the scoring function used, the scores may be all the same within some small region. As can be seen in the fourth GPi dataset, often automated matching results will produce multiple results due to the score being exactly equal within that region. The MicroAtlas program presents all the results to the user for consideration. The matching results in Table 2 did not use a transformed atlas as the transformation of the atlas to the patient MRI was not available. The matching results are expected to improve if a transformed atlas is used.

TABLE 2
Matching results using the digital reconstruction of the sagittal atlas.

| | Target | AP (mm) | | Lateral (mm) | | Axial (mm) | |
|---|---|---|---|---|---|---|---|
| 1 | GPi | −1 | [1.5] | −1 | [−1] | −5 | [−5] |
| 2 | GPi | 0 | [0] | 0 | [0.5] | −4 | [−2.5] |
| 3 | GPi | 0 | [0] | 2 | [2.5] | −7 | [−7.5] |
| 4 | GPi | 1 | [0, 0.5, 0.5] | −3 | [−3.5, −3.5, −3.5] | −4.5 | [−4.5, −5, −4] |
| 5 | STN | −1 | [−0.5] | 0 | [0] | −0.5 | [0] |
| 6 | STN | −1 | [−3] | −0.5 | [1.5] | −1 | [−1] |
| 7 | STN | 0 | [−1] | −1.5 | [−2.5] | −1.5 | [−1.5] |
| 8 | STN | −2 | [0] | 0 | [2.5] | 0 | [−2] |

The distances are the distances in millimeters required to move the tracks from patient anatomical coordinates to the corresponding position in the atlas. The numbers in brackets are the automated results.

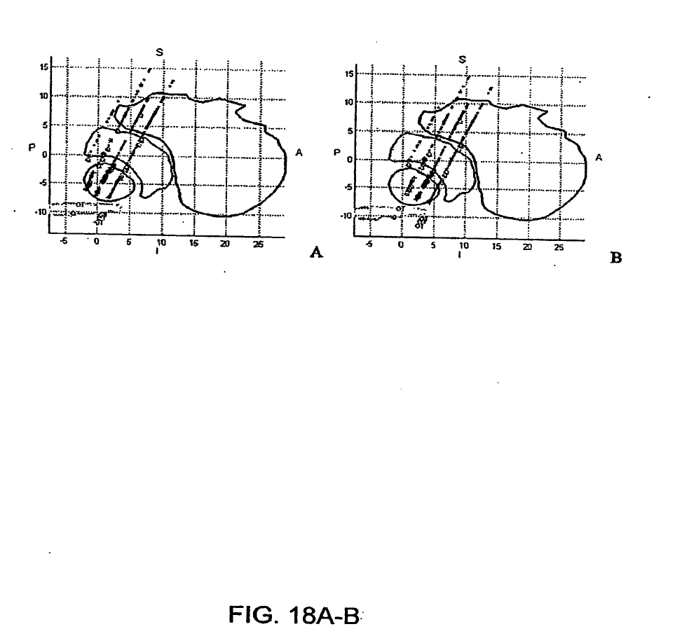

An example of a comparison of manual versus automated matching is given in FIG. 18. The atlas used is the digitized reconstruction of the sagittal sections of the Schaltenbrand-Bailey atlas. The atlas was not deformed to fit the patient's anatomy. More specifically, FIG. 18 illustrates matching results for a GPi case using the MicroAtlas program. FIG. 18A is a manual match and FIG. 18B is an automated match. Both matches were independently matched to the same sagittal plane (22 mm). In a color representation of FIG. 18, blue points and contours correspond to striatum, green points and contours correspond to GPe, red points and contours correspond to GPi, and yellow points and contours correspond to optic tract.

Qualitatively, it can be seen that automated matching may produce a result that is distinctly different from the manual result, Since the matching and scoring algorithm takes into account each point of data, the number of points in the dataset is significant. From FIG. 18, it can be seen that whereas FIG. 18A correctly matches the boundaries, FIG. 18B produces an incorrect match that is more anterior.

The score itself can provide information on the quality of the match. The scoring method outlined previously gives a simple score that is in the range between 1 and −1, with 1 being the best possible score and −1 being the worst. While 1 is the best score, a score of 1 does not necessarily suggest that the match is correct. For example, in the case of a single track with only a few points of data, there may be numerous positions that fit well with the data, but the match itself may not be correct since there is not enough data to accurately determine a proper match position. The score is better stated as a measure of how much or little the data conflicts with the atlas at a given position. By this definition, a poor score can determine that the data does not fit with the atlas description of the anatomy at that position, but a good score only suggests that the data does not conflict with the atlas.

The deviations of a manual match compared to an automated match may stem from the atlas being a poor representation of the patient's anatomy and/or poor microelectrode data. The automated matching algorithm is fairly robust to situations with poor data, due to consideration of the uncertainty within every data point as dictated by user data entry. The boundary is considered implicitly in the score with points such as “Quiet” points, but how these points are weighted in the score depends on the number of these data points acquired. While an expert may have a qualitative idea of when or where the data is poor, the algorithm considers both the number and certainty of the data points in the score which may lower the weighting that poor data points has on the score. While the atlas can be deformed to fit the patient's anatomy, only an affine deformation is considered, which still may not produce an adequate representation of the patient's anatomy. If the deformed atlas is still not an accurate representation of the patient's anatomy, the automated matching algorithm may again produce erroneous results, as a proper match position would not exist within the atlas.

3.4 Evaluation of the DBS Guidance System in a Clinical Setting

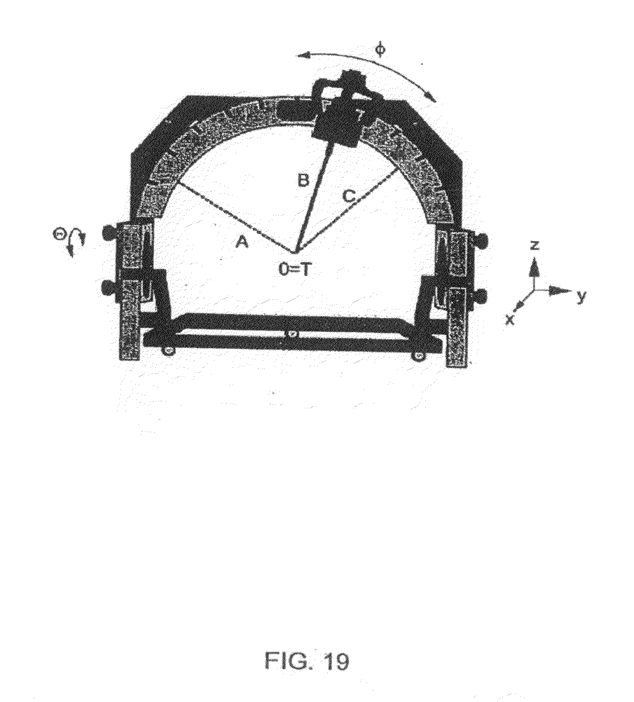

As is well known in the art, the most important coordinate system used in DBS systems as described herein is that of the head ring. The head ring coordinate system is typically used in reference to the patient's CT image. The head ring used for deep brain stimulation on patients used in testing an embodiment of the system described herein was a CRW head ring, which is a target-centered head ring as described by Zylka et al. (8). A drawing of such a head ring is provided in FIG. 19.

Referring to FIG. 19, the x, y, and z Cartesian axes are the directions for movement of the target position on the head ring. Using these three adjustments, a target point can be chosen on the patient's cranium. To set the head ring for the appropriate entry angle, two angular adjustments can be made on the collar and on the arc. The arc angle is Φ in FIG. 19 and the collar angle is Θ in FIG. 19; using these two angles, an entry angle can be obtained.

Once a target point and entry angles have been defined with respect to the CT coordinate system, the anterior commissure (AC), posterior commissure (PC), and a mid-sagittal point (central line point) must be chosen in order to define an anatomical landmark-based coordinate system. A new anatomic coordinate system based on the AC, PC, and central line point (CLP) can be found with respect to the CRW head ring coordinate system using the following equations:

$${\hat{x}}^{′} = \frac{{\hat{y}}^{′} \times {\hat{z}}^{′}}{‖ {\hat{y}}^{′} \times {\hat{z}}^{′} ‖}$$

$${\hat{y}}^{′} = \frac{AC - PC}{‖ AC - PC ‖}$$

$${\hat{z}}^{′} = \frac{( CLP - PC ) - {\hat{y}}^{′} [ ( CLP - PC ) \cdot {\hat{y}}^{′} ]}{‖ ( CLP - PC ) - {\hat{y}}^{′} [ ( CLP - PC ) \cdot {\hat{y}}^{′} ] ‖}$$

These equations can be used to create a transformation matrix that allows a point in CRW space to be transformed into anatomic space.

The system described herein provides for an improved targeting system for deep brain stimulation electrode placement, and was tested extensively in a clinical setting. The DBS Data Acquisition program was tested intraoperatively, with multiple users, to ensure that it is simple to use and that data can be quickly acquired. As discussed above, the design of the data acquisition program includes components for redundancy. These redundancies, such as an auto-save feature and data mirroring, have been tested and found to work well to minimize the potential for data loss.

The other programs in the system have been tested individually as described above, and developed with consideration of input from clinicians practicing in the area of deep brain stimulation neurosurgery.

3.5 Other Embodiments of DBS Guidance System

As described above, an embodiment of the DBS guidance system has been tested and found to perform well in a clinical setting. Two major areas of system or algorithm development are envisioned to further enhance the systems described in the Examples herein.

In one aspect, patient-specific brain maps are envisioned. As previously discussed, the matching process relies upon the atlas being able to sufficiently model the patient's anatomy. While the MRAtlas program is able to transform the atlas to better fit the patient's anatomy, in this program an affine transformation is used. The affine transformation may be sufficient for most patients. Nevertheless, allowing for a non-rigid deformation may be preferable for some patients.

A non-rigid deformation of the atlas may produce a deformation of the atlas that better fits the patient's anatomy by allowing the atlas structures to be shaped in a non-linear sense (26). The option to perform this deformation may be preferred for patients with enlarged ventricles, tumors, or other anatomic abnormalities that would greatly change the shape of the subcortical structures. Alternatively, more atlases, or a probabilistic atlas, may offer more choices from which clinicians may select the best one to fit the particular patient's anatomy.

Additionally, since the microelectrode data contains some information regarding the patient's anatomy, these data also may be helpful in the creation of a probabilistic atlas, or to augment the anatomic data of the atlas with physiological information.

One limitation of the current system is its implementation within the Matlab programming environment. Advantageously, Matlab allows for a quick transition from concept to implementation; however, the Matlab environment is too slow to consider adding many features. In addition, the graphical user interface options through Matlab are somewhat limited. Accordingly, commercial embodiments of the system are contemplated to run from a more robust language such as the Visualization Toolkit (VTK) or others. As a non-limiting example, C+ would be able to offer the desired speed and to overcome the feature limitations of Matlab.

As a result of the inventive improvements described herein, it is believed that implementation of these systems and methods will make the intraoperative process of DBS surgery faster, more accurate, and more cost effective.

### REFERENCES

It is believed that a review of the references will increase appreciation of the present invention. The following documents are referred to throughout the present disclosure by a number, as indicated below. The disclosure of all references cited herein is hereby incorporated by reference.
1. K. A. Follet, “The Surgical Treatment of Parkinson's Disease,” Annu. Rev. Med. 51, 135-147 (2000).
2. Z. H. T. Kiss, M. Wilkinson, J. Krcek, O. Suchowersky, B. Hu, W. F. Murphy, D. Hobson, and R. R. Tasker, “Is the Target for Thalamic Deep Brain Stimulation the Same as for Thalamotomy,” Mov. Disord. 18, 1169-1175 (2003).
3. Y. Temel and V. Visser-Vandewalle, “Surgery in Tourette Syndrome,” Mov. Disord. 91, 3-14 (2004).
4. P. A. Starr, J. L. Vitek, and R A. E. Bakay, “Abalative Surgery and Deep Brain Stimulation for Parkinson's Disease,” Neurosurgery 43, 989-1015 (1998).
5. C. M. Duma, D. B. Jacques, O. V. Kopyov, R. J. Mark, B. Copcutt, and H. K. Farokhi, “Gamma Knife Radiosurgery for Thalamotomy in Parkinsonian Tremor: A Five-Year Experience,” J. Neurosurg. 88, 1044-1049 (1998).
6. M. S. Okun, N. P. Stover, T. Subramanian, M. Gearing, B. H. Wainer, C. A. Holder, R. L. Watts, J. L. Juncos, A. Freeman, M. L. Evatt, S. U. Schuele, J. L. Vitek, and M. R. DeLong, “Complications of Gamma Knife Surgery for Parkinson's Disease,” Arch. Neurol. 58, 1995-2002 (2001).
7. C. C. McIntyre, M. Savasta, B. L. Walter, and J. L. Vitek, “How Does Deep Brain Stimulation Work? Present Understanding and Future Questions,” J. Clin. Neurophysiol. 21, 40-50 (2004).
8. W. Zylka, J. Sabczynski, and G. Schmitz, “A Gaussian Approach for the Calculation of the Accuracy of Stereotactic Frame Systems,” Med. Phys. 26, 381-391 (1999).
9. J. L. Vitek, R A. Bakay, T. Hashimoto, Y Kaneoke, K. Mewes, J. Y Zhang, D. Rye, P. Starr, M. Baron, R Turner, M. R. Delong, “Microelectrode-Guided Pallidotomy: Technical Approach and its Application in Medically Intractable Parkinson's Disease,” J. Neurosurg. 88, 1027-1043 (1998).
10. G. Schaltenbrand and W. Wahren, Atlas for Stereotaxy of the Human Brain. (George Thieme Verlag, Stuttgart, 1977).
11. G. Schaltenbrand and P. Bailey, Atlas of Stereotaxy of the Human Brain. (George Thieme Verlag, Stuttgart, 1959).
12. J. Talairach and P. Tournoux, Co-Planar Stereotaxic Atlas of the Human Brain. (George Thieme Verlag/Thieme Medical Publishers, Stuttgart, 1988).
13. R W. Cox, “AFNI: Software for Analysis and Visualization of Functional Magnetic Resonance Neuroimages,” Comput. Biomed. Res. 29, 162-173 (1996).
14. H. Hirabayashi, M. Tengvar, M. I. Hariz, “Stereotactic Imaging of the Pallidal Target,” Mov. Disord. 17, S130-S134 (2002).
15. J. Talairach and P. Toumoux, Referentially Oriented Cerebral MRI Anatomy. Atlas of Stereotaxic Anatomical Correlations for Gray and White Matter. (Georg Thieme Verlag/Thieme Medical Publishers, Stuttgart, 1993).
16. M. Ono, S. Kubik, C. D. Abernathey, Atlas of the Cerebral Sulci. (Georg Thieme Verlag/Thieme Medical Publishers, Stuttgart, 1990).
17. W. L. Nowinski, A. Fang, B. T. Nguyen, J. K. Raphel, L. Jagannathan, R. Raghavan, R. N. Bryan, and G. A. Miller, “Multiple Brain Atlas Database and Atlas-Based Neuroimaging System,” Comp. Aid. Surg. 2, 42-66 (1997).
18. M. I. Kazarnovskaya, S. M. Borodkin, V. A. Shabalov, V. Y. Krivosheina, and A. V. Golanov, “3-D Computer Model of Subcortical Structures of Human Brain,” Comput. Biol. Med. 22, 451-457 (1991).
19. K. Niemann, C. Naujokat, G Pohl, C. Wollner, and D. von Keyserlingk, “Verification of the Schaltenbrand and Wahren stereotactic atlas,” Acta Neurochir. 129, 72-81 (1994).
20. M. Yoshida, “Creation of a three-dimensional atlas by interpolation from Schaltenbrand-Bailey's atlas,” Appl. Neurophysiol. 50, 45-48 (1987).
21. K. A. Ganser, H. Dickhaus, R. Metzner, and C. R. Wirtz, “A deformable digital brain atlas system according to Talairach and Tournoux,” Med. Image Anal. 8, 3-22 (2004).
22. D. T. Lee and B. J. Schachter, “Two Algorithms for Constructing a Delaunay Triangulation,” Int. J. Computer Information Sci. 9, 219-242, (1980).
23. A Okabe, B. Boots, and K. Sugihara, Spatial Tessellations: Concepts and Applications of Voronoi Diagrams. (Wiley, New York, 1992).
24. C. B. Barber, D. P. Dobkin, and H. T. Huhdanpaa, “The Quickhull Algorithm for Convex Hulls,” ACM Trans. Mathematical Software, 22, 469-483, (1996)
25. D. Meyers, S. Skinner, and K. Sloan, “Surfaces from Contours,” ACM Trans. On Graphics, 11, 228-258, (1992).
26. T. S. Yoo, Insight into Images. (A. K. Peters, Wellesley, 2004).

The invention has been described in detail with reference to preferred embodiments thereof. However, it will be appreciated that those skilled in the art, upon consideration of this disclosure, may make modifications and improvements that are within the spirit and scope of the invention.

What is claimed is:

1. A computer-implemented three-dimensional neuroanatomic map of the brain comprising digitized images of anatomic structures, contours, and reference points in the brain that may be visualized unambiguously on a display in two or three dimensions, and viewed from any desired plane of section through said brain.

2. The computer-implemented neuroanatomic brain map of claim 1, wherein said three-dimensional images are constructed using digitized information contained in a series of two-dimensional images depicting brain structures and functions in discontinuous sections through a reference brain from one or more subjects.

3. The computer-implemented neuroanatomic brain map of claim 2, wherein said discontinuous sections of said reference brains are oriented through the sagittal, axial, or coronal planes of section.

4. The computer-implemented neuroanatomic brain map of claim 2, wherein the digitized information is obtained from discontinuous sections oriented through at least two of said planes of section from one or more reference brains.

5. The computer-implemented neuroanatomic brain map of claim 2, wherein the sections are aligned with each other using an anatomic coordinate system.

6. The computer-implemented neuroanatomic brain map of claim 2, wherein the discontinuous sections are in sagittal orientation and the horizontal axis defines the commissural line, and the vertical axis defines the mid-commissural plane.

7. The computer-implemented neuroanatomic brain map of claim 2, wherein the discontinuous sections are in axial orientation and a single horizontal axis in each section defines the mid-commissural plane, with the most medial portion of that axis defining the mid-sagittal plane.

8. The computer-implemented neuroanatomic brain map of claim 7, wherein the coordinates are calculated to account for the deviation of Reid's plane from the AC-PC plane.

9. The computer-implemented neuroanatomic brain map of claim 1, wherein the digitized images comprise only the contours of structures of interest in said brain.

10. The computer-implemented neuroanatomic brain map of claim 9, wherein undesired features of said structures of interest are removed.

11. The computer-implemented neuroanatomic brain map of claim 9, wherein the surface and volume of an anatomic structure of interest defined by a set of points are determined by linear interpolation using triangulation of the points or tessellation of contours.

12. The computer-implemented neuroanatomic brain map of claim 11, wherein the surface is smoothed using voxelization or a smoothing algorithm implemented by convolving with a smoothing kernel.

13. The computer-implemented neuroanatomic brain map of claim 11, wherein the volume is determined using Delaunay tetrahedrization.

14. The computer-implemented neuroanatomic brain map of claim 1, comprising images combined from two or more voxelized atlases.

15. The computer-implemented neuroanatomic brain map of claim 9, wherein the digitally constructed brain map is compared with a three-dimensional model generated from the data used to construct the brain map.

16. A computerized system for enhancing visualization of structures in three-dimensional space in medical images of the brain of a subject, comprising:
(a) a processor for displaying medical images of the subject's brain;
(b) an algorithm for generating a three-dimensional neuroanatomic brain map;
(c) an algorithm for converting the medical images of (a) to images capable of integration with the three-dimensional neuroanatomic brain map of (b);
(d) a user interface for entering reference points from the subject's medical brain images that define reference points in an anatomically-based coordinate system;
(e) an algorithm for transforming data points in the subject's medical image from stereotactic space to anatomic coordinates in the three-dimensional neuroanatomic brain map; and
(f) an algorithm for overlaying images of a three-dimensional brain map on the subject's medical images; and optionally translating and scaling the three-dimensional brain map images to fit the subject's medical images, thereby enhancing visualization of structures in medical images of the brain.

17. The system according to claim 16, wherein the medical image of the brain is obtained using a medical imaging device selected from the group consisting of a MRI device, a CT scanner, an ultrasound device, and an X-ray device.

18. A computerized data acquisition system for deep brain stimulation (DBS), comprising:
(a) a user interface for inputting information;
(b) at least one algorithm for receiving inputted information selected from the group consisting of main patient information, microelectrode track information, Unified Parkinson's Disease Rating Scale (UPDRS), Tremor Rating Scale (TRS), microelectrode data, microstimulation data, motor function measurements, and macrostimulation data; and
(c) a plotting and printing routine.

19. The computerized DBS data acquisition system of claim 18, further configured to store saved information in one or more independent sites.

20. The computerized DBS data acquisition system of claim 18, wherein microelectrode data that can be entered into the system is selected from the group consisting of electrode number, time of recording, depth of the electrode, position of the electrode in a fixed three-dimensional coordinate system, quality of the recording, cell type descriptor, location of recorded cell and certainty thereof, body part location, motor function measurements, and movement associated with a cell.

21. The computerized DBS data acquisition system of claim 20, wherein the location of the body part is selected from the group consisting of striatum, thalamus, Voa, Vop, Vim, Vc, STN, SNr, GPe, GPi, ansa lenticularis, ZI, internal capsule, optic tract, border of striatum, border of thalamus, border of Voa, border of Vop, border of Vim, border of Vc, border of STN, border of SNr, border of GPe, border of GPi, border of ansa lenticularis, border of ZI, border of internal capsule, border of optic tract, nucleus accumbens, top, bottom, and other.

22. The computerized DBS data acquisition system of claim 18, wherein the cell type descriptor is selected from the group consisting of unidentified negative potential (Neg), injury, popcorn, bursting, pausing, high frequency discharge (HFD), low frequency discharge (LFD-P), chugging, low amplitude, high amplitude, tactile, light touch, rhythmic, background up, background down, quiet, and other.

23. The computerized DBS data acquisition system of claim 18, wherein the body part location is selected from the group consisting of face, cheek, inner mouth, tongue, jaw, chin, neck, shoulder, elbow, arm, hand, wrist, finger, hip, leg, knee, ankle, foot, and toes.

24. The computerized DBS data acquisition system of claim 18, wherein the movement associated with the cell is selected from the group consisting of abduction, adduction, extension, flexion, internal rotation, external rotation, dorsiflexion; and plantar flexion.

25. The computerized DBS data acquisition system claim 18, wherein the microstimulation data is selected from the group consisting of depth of stimulation, type of stimulation (electrical or light), current of stimulation, and response to stimulation (positive or negative).

26. An image guidance system for deep brain stimulation (DBS), comprising:
(a) a computerized system for enhancing visualization of structures in three-dimensional space in medical images of the brain of a subject, comprising:
algorithms for transforming data points in the subject's medical brain images from stereotactic space to anatomic coordinates in a three-dimensional neuroanatomic brain map, and for overlaying images of the three-dimensional brain map on the subject's medical images;
(b) a computerized DBS data acquisition system; and
(c) an algorithm that permits the user to display an enhanced three-dimensional neuroanatomic map of the brain from (a) and digitized microelectrode data from the data acquisition system of (b), wherein the microelectrode data appears as an overlay on a three-dimensional neuroanatomic map of the subject's brain.

27. The DBS image guidance system of claim 26, wherein the system (a) for enhancing visualization of structures in three-dimensional space in medical images of the brain of a subject comprises at least one of:
a processor for displaying medical images of the subject's brain;
an algorithm for displaying a three-dimensional neuroanatomic brain map;
an algorithm for converting the medical images of the brain to images capable of integration with said three-dimensional neuroanatomic brain map;
a user interface for entering reference points from the subject's medical brain images that define reference points in an anatomically-based coordinate system;
an algorithm for transforming data points in the subject's brain image from stereotactic space to anatomic coordinates in the neuroanatomic brain map; and
an algorithm for overlaying images of a three-dimensional brain map on the subject's medical images; and optionally translating and scaling the three-dimensional brain map, thereby enhancing visualization of structures in the medical images of the brain.

28. The DBS image guidance system of claim 26, wherein the data acquisition system of (b) comprises at least one of:
a user interface for inputting information;
algorithms for receiving inputted information selected from the group consisting of main patient information, microelectrode track information, Unified Parkinson's Disease Rating Scale (UPDRS), Tremor Rating Scale (TRS), microelectrode data, microstimulation data, motor function measurements, and macrostimulation data; and
a plotting and printing routine.

29. The DBS image guidance system of claim 26, wherein microelectrode tracks can be visualized in a para-sagittal view, a para-coronal view, or a three-dimensional view.

30. The DBS image guidance system of claim 29, wherein a selected portion of the brain map and the corresponding microelectrode tracks, or the entire brain map and all of the microelectrode tracks, can be displayed.

31. The DBS image guidance system according to claim 26, wherein the medical image of the brain is obtained using a medical imaging device selected from the group consisting of a MRI device, a CT scanner, an ultrasound device, and an X-ray device.
